(19) United States
(12) Patent Application Publication
(10) Pub. No.: US 2026/0282168 A1
(43) Pub. Date: Sep. 17, 2026

(54) HEATING APPARATUS FOR FACILITATING UNIFORM HIGH-POWER HEATING OF LIQUID AND METHODS OF MANUFACTURING A HEATING APPARATUS

(71) Applicant: James Azotea, Saratoga Springs, NY (US)

(72) Inventor: James Azotea, Saratoga Springs, NY (US)

(21) Appl. No.: 19/562,849

(22) Filed: Mar. 11, 2026

Related U.S. Application Data
(60) Provisional application No. 63/770,514, filed on Mar. 12, 2025.

(51) Int. Cl. H05B 1/02; H05B 3/76

(52) U.S. Cl. CPC H05B 1/0244; H05B 3/76

(57) ABSTRACT

The present disclosure describes a heating apparatus for facilitating uniform high-power heating of liquid. Further, the heating apparatus includes a frame formed from horizontal members and vertical members joined to define an open structure. The frame is configured for supporting a load. The heating apparatus includes a heater comprising at least one heating element configured for generating heat. The heating apparatus includes a diffusion plate positioned above the heater. Further, a flat lower surface of the diffusion plate faces an upper heat-emitting surface of the heater to receive the heat from the upper heat-emitting surface, and upper surface of the diffusion plate is configured for direct contact with a bottom surface of a container. Further, the flat upper surface is configured for transferring the heat to the bottom surface uniformly. The heating apparatus includes a controller configured for regulating an electrical power supplied to the heater.

### REFERENCE TO RELATED APPLICATIONS

This application claims the benefit of U.S. Provisional Patent Application No. 63/770,514, titled “KILOWATT HEATING APPARATUS WITH DIFFUSION PLATE INTEGRATED WITHIN THE FRAME”, filed on Mar. 12, 2025, which is incorporated by reference herein in its entirety.

### FIELD OF DISCLOSURE

The present disclosure relates to the field of heating. More specifically, the present disclosure relates to heating an apparatus for facilitating uniform high-power heating of liquid and methods of manufacturing a heating apparatus.

### BACKGROUND

The present disclosure relates generally to the field of thermal processing equipment and, more particularly, to electrically powered heating apparatuses used for transferring heat to containers holding liquid or semi-liquid materials. The field of thermal processing equipment is important in a wide range of applications, including food preparation, beverage production, chemical processing, and other industries where controlled heating of liquids is required. Reliable and efficient heating systems play a critical role in ensuring process consistency, product quality, operational safety, and energy efficiency.

A desirable objective in the field is to provide a heating apparatus capable of delivering high levels of thermal energy to a liquid in a controlled and uniform manner while maintaining structural stability and operational reliability. In particular, there is a need to achieve rapid heating without causing localized overheating, degradation of the heated material, or excessive mechanical or thermal stress on system components. Achieving the above objective becomes increasingly challenging as heating power levels increase and as container sizes and liquid volumes grow.

Existing heating apparatuses often rely on localized heat sources positioned directly beneath a container, which may result in uneven heat distribution across the container interface. Such uneven heating may lead to the formation of hot spots, thermal gradients, or localized regions of excessive temperature. The above conditions may cause undesirable effects such as scorching, burning, or degradation of temperature-sensitive materials, particularly when heating liquids containing dissolved solids or organic compounds. Additionally, localized heating may reduce process efficiency by requiring lower operating power or longer heating times to avoid damage.

Another problem encountered with existing systems is mechanical instability caused by the direct placement of heavy containers on heating elements or insufficiently supported structures. As container size and liquid volume increase, the resulting load may stress or deform heating components, leading to misalignment, reduced heat transfer efficiency, or premature failure. Thermal expansion and contraction during operation may further exacerbate the mechanical issues, resulting in inconsistent performance over time.

Electrical heating apparatuses may also suffer from inefficient thermal interfaces between the heat source and the container. Poor contact, air gaps, or irregular surfaces can increase thermal resistance, requiring higher temperatures at the heat source to achieve a desired heating rate. The above limitations may elevate operating temperatures, reduce component lifespan, and increase energy consumption. Additionally, insufficient management of transient thermal behavior may lead to unstable temperature control during power changes, start-up, or shutdown.

Control and safety challenges may also arise in high-power heating systems. Separating electrical components from high-temperature zones, maintaining predictable thermal behavior, and managing power delivery in response to changing thermal conditions can be difficult with existing designs. The above challenges may limit scalability, adaptability, and overall usability of heating apparatuses in demanding applications.

Therefore, there is a need for improved apparatuses for facilitating uniform high-power heating of liquid that can overcome one or more of the preceding problems.

### SUMMARY OF DISCLOSURE

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present disclosure describes a heating apparatus for facilitating uniform high-power heating of liquid. Further, the heating apparatus may include a frame comprising a rigid elongated body formed from two or more horizontal members and two or more vertical members joined to define an open structure having an upper plane and a lower plane. Further, the frame may be configured for supporting a load above the upper plane. Further, the heating apparatus may include a heater comprising one or more heating elements formed as a continuous metal coil having an upper heat-emitting surface and a lower mounting surface. Further, the heater may be mechanically attached to the frame. Further, the upper heat-emitting surface of the heater may be oriented upward. Further, the heater may be configured for generating heat. Further, the heating apparatus may include a diffusion plate comprising a solid planar metal body having a flat upper surface and a flat lower surface. Further, the diffusion plate may be positioned above the heater. Further, the diffusion plate may be mechanically integrated with the frame. Further, the flat lower surface of the diffusion plate faces the upper heat-emitting surface of the heater to receive heat from the upper heat-emitting surface. Further, the flat upper surface of the diffusion plate may be configured for direct contact with a bottom surface of a container containing the liquid. Further, the flat upper surface may be configured for transferring the heat to the bottom surface of the container uniformly to reduce at least one of caramelization of the sugar in the liquid and burning of the sugar in the liquid on the bottom surface of the container. Further, the heating apparatus may include a controller electrically connected to the heater. Further, the controller may be configured for regulating an electrical power supplied to the heater to control the generating of the heat. Further, the heating apparatus may include a power terminal configured to receive the electrical power. Further, the power terminal may be electrically coupled to each of the heater and the controller.

The present disclosure describes a heating apparatus for facilitating uniform high-power heating of liquid. Further, the heating apparatus may include a frame which may be configured for supporting a container. Further, the heating apparatus may include a heater attached to the frame. Further, the heater may be configured for generating heat. Further, the heating apparatus may include a diffusion plate mechanically integrated with the frame. Further, the diffusion plate may be positioned between the heater and the container. Further, the diffusion plate may be configured for receiving the heat from the heater. Further, the diffusion plate may be configured for distributing the heat uniformly to the container containing the liquid. Further, the liquid may include sugar. Further, the distributing of the heat uniformly to the container reduces one or more of caramelization of the sugar in the liquid and burning of the sugar in the liquid on the bottom surface of the container. Further, the heating apparatus may include a controller electrically coupled to the heater. Further, the controller may be configured for regulating a power supplied to the heater to control the generating of the heat.

The present disclosure describes a heating apparatus for facilitating uniform high-power heating of liquid. Further, the heating apparatus may include a frame comprising a rigid elongated body formed from two or more horizontal members and two or more vertical members joined to define an open structure having an upper plane and a lower plane. Further, the frame may be configured for supporting a load above the upper plane. Further, the heating apparatus may include a heater comprising one or more heating elements formed as a continuous metal coil having an upper heat-emitting surface and a lower mounting surface. Further, the heater may be mechanically attached to the frame by facing the upper heat-emitting surface upward. Further, the heater may be configured for generating heat. Further, the heating apparatus may include a diffusion plate comprising a solid planar metal body having a flat upper surface and a flat lower surface. Further, the diffusion plate may be positioned above the heater. Further, the diffusion plate may be mechanically integrated with the frame. Further, the flat lower surface of the diffusion plate faces the upper heat-emitting surface of the heater to receive heat from the upper heat-emitting surface. Further, the flat upper surface of the diffusion plate may be configured for direct contact with a bottom surface of a container containing the liquid. Further, the flat upper surface may be configured for transferring the heat to the bottom surface of the container uniformly to reduce one or more of caramelization of sugar in the liquid and burning of the sugar in the liquid on the bottom surface of the container. Further, the solid planar metal body of the diffusion plate includes a monolithic metal plate body having a continuous internal volume and two or more opposing major faces. Further, the monolithic metal plate body may be formed from a material exhibiting high thermal conductivity. Further, the heat may be received from the upper heat-emitting surface at a localized region on the flat lower surface spreads laterally across the continuous internal volume before the heat is reaching the flat upper surface. Further, the transferring of the heat to the bottom surface may be based on the reaching of the flat upper surface by the heat. Further, the heating apparatus may include a controller electrically connected to the heater. Further, the controller may be configured for regulating an electrical power supplied to the heater to control the generating of the heat. Further, the heating apparatus may include a power terminal configured to receive the electrical power. Further, the power terminal may be electrically coupled to each of the heater and the controller.

The present disclosure provides a method of manufacturing a kilowatt heating apparatus. Further, the method may include receiving, by a material handling station, two or more elongated metal frame members formed as extruded profiles. Further, the method may include cutting, by a machining station, the two or more elongated metal frame members to predefined lengths corresponding to two or more horizontal members and two or more vertical members of a frame. Further, the method may include fastening, by an assembly fixture, the two or more horizontal members and the two or more vertical members together using flanged button head socket cap screws and inside corner brackets to form a rigid elongated body of the frame, defining an upper plane and a lower plane. Further, the method may include positioning, by a placement tool, a heater within the frame by facing an upper heat-emitting surface upward. Further, the heater includes at least one heating element having the upper heat-emitting surface and a lower mounting surface. Further, the heater may be configured for generating heat. Further, the method may include attaching, by a mechanical fastening tool, the heater to the frame to maintain a fixed spatial relationship between the heater and the frame. Further, the method may include forming, by a plate fabrication station, a diffusion plate as a solid planar metal body having a flat upper surface and a flat lower surface. Further, the method may include mounting, by a fastening assembly, the diffusion plate to the frame above the heater to reduce at least one of caramelization of sugar in the liquid and burning of the sugar in the liquid. Further, the flat lower surface of the diffusion plate faces the upper heat-emitting surface of the heater, and the flat upper surface of the diffusion plate may be exposed for a direct contact with a bottom surface of a container containing the liquid. Further, the method may include installing, by an enclosure mounting station, a controller in accordance with National Electric Code (NEC) requirements onto the frame. Further, the controller may be compliant with UL 508 safety standards. Further, the method may include electrically connecting, by a wiring station, the controller to the heater in accordance with the NEC requirements to enable regulating of an electrical power supplied to the heater. Further, the method may include electrically connecting, by the wiring station, a power terminal to each of the heater and the controller in accordance with the NEC requirements. Further, the power terminal may be configured to receive the electrical power.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTIONS OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 illustrates a front view of a heating apparatus 100 for facilitating uniform high-power heating of liquid, in accordance with some embodiments.

FIG. 2 illustrates a top view of the heating apparatus 100 in absence of a diffusion plate 110 for facilitating uniform high-power heating of liquid, in accordance with some embodiments.

FIG. 3 illustrates a top view of the heating apparatus 100 in absence of the diffusion plate 110 and one or more heating elements (202-206) for facilitating uniform high-power heating of liquid, in accordance with some embodiments.

FIGS. 4A and 4B illustrate a heating element 202 of the heating apparatus 100 for facilitating uniform high-power heating of liquid, in accordance with some embodiments.

FIG. 5 illustrates the frame 102 and diffusion plate 110 of the heating apparatus 100 for facilitating uniform high-power heating of liquid, in accordance with some embodiments.

FIG. 6 illustrates a perspective view of the heating apparatus 100 for facilitating uniform high-power heating of liquid, in accordance with some embodiments.

FIG. 7 illustrates a mechanical fastener 118 of the heating apparatus 100 for facilitating uniform high-power heating of liquid, in accordance with some embodiments.

FIG. 8 illustrates a perspective view of the heating apparatus 100 for facilitating uniform high-power heating of liquid, in accordance with some embodiments.

FIG. 9 illustrates an electrical box 208 mounted on a bracket assembly 332 of the heating apparatus 100 for facilitating uniform high-power heating of liquid, in accordance with some embodiments.

FIG. 10 illustrates a thermal shield 602 of the heating apparatus 100 for facilitating uniform high-power heating of liquid, in accordance with some embodiments.

FIG. 11 illustrates a rear view of the heating apparatus 100 for facilitating uniform high-power heating of liquid, in accordance with some embodiments.

FIG. 12 illustrates a perspective view of the heating apparatus 100 for facilitating uniform high-power heating of liquid, in accordance with some embodiments.

FIG. 13 illustrates a perspective view of the heating apparatus 100 for facilitating uniform high-power heating of liquid, in accordance with some embodiments.

FIG. 14 illustrates a perspective view of the heating apparatus 100 for facilitating uniform high-power heating of liquid, in accordance with some embodiments.

FIG. 15 illustrates a side view of the diffusion plate 110, in accordance with some embodiments.

FIG. 16 illustrates a perspective view of a receptacle block 902 of the apparatus 100, in accordance with some embodiments.

FIG. 17 illustrates a bottom view of a metal receptacle bracket 1702, in accordance with some embodiments.

FIG. 18 illustrates a perspective view of a first adjustable support membrane 314, in accordance with some embodiments.

FIG. 19 illustrates a heating apparatus 1900 for facilitating uniform high-power heating of liquid, in accordance with some embodiments.

FIG. 20 illustrates a heating apparatus 2000 for facilitating uniform high-power heating of liquid in a container while reducing localized overheating, in accordance with some embodiments.

FIG. 21A illustrates a First Diffusion Plate and Water Temperature vs. Time graph 2102, in accordance with some embodiments.

FIG. 21B illustrates a Second Diffusion Plate and Water Temperature vs. Time graph 2104, in accordance with some embodiments.

FIG. 22A illustrates a thermal circuit 2200 for the heating apparatus 100, in accordance with some embodiments.

FIG. 22B illustrates a continuation of the thermal circuit 2200 for the heating apparatus 100, in accordance with some embodiments.

FIG. 23A illustrates a first validation graph 2300, in accordance with some embodiments.

FIG. 23B illustrates the validation graph 2300, in accordance with some embodiments.

FIG. 24 illustrates a table 2400 representing one or more circuit components comprised in the thermal circuit 2200, in accordance with some embodiments.

FIG. 25A illustrates a flowchart of a method 2500 of manufacturing a heating apparatus, in accordance with some embodiments.

FIG. 25B illustrates a continuation of the flowchart of the method 2500 of manufacturing a heating apparatus, in accordance with some embodiments.

### DETAILED DESCRIPTION OF DISCLOSURE

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of the disclosed use cases, embodiments of the present disclosure are not limited to use only in this context.

### Overview:

The present disclosure describes a kilowatt heating apparatus with a diffusion plate integrated within the frame. The present disclosure describes a high-performance brewing hotplate (BHP). The BHP may be designed to ensure the mechanical stability of the brewing structure during large-scale home-brewed beer production and to greatly reduce the caramelization of sugary wort when heated at high-power levels to minimize the overall brew day duration. The frame incorporates a diffusion plate designed to eliminate thermal hot spots on the bottom surface of the brew pot. The above feature helps to prevent wort caramelization, which may lead to the creation of non-fermentable sugars that alter the beer flavor profile by adding sweetness and body to the final beer. The system's power may be adjustable to prevent “boil-overs” and achieve a steady, vigorous boil, which is critical to driving off dimethyl sulfide (DMS) from the wort during the boiling process. The above features may reduce cooked corn and sulfur flavors in the finished beer. The controller incorporates solid-state or electromechanical thermal switching devices to control the heat level that is transferred to the liquid in the brew pot.

The heating of water is one of the most time-consuming tasks in the homebrewing process. A primary goal of the home brewer is to heat water and wort as quickly as possible to shorten the brewing day's duration. When heating liquids during the brewing process, it is best to use the maximum amount of power to raise the temperature across the thermal capacitances of the water and the brewing pot to the final temperature in the shortest amount of time. The boiling phase of homebrewing involves heating a malty, sugary wort, which may caramelize, scorch, or burn if high heat is applied to a brew pot with a thin bottom made from a highly thermally conductive material.

A durable, thick aluminum diffusion plate is installed between the source of high heat and the base of the brew pot, allowing for the even distribution of heat across the thin, thermally conductive bottom of the brew pot. The above arrangement effectively reduces “hot spot” temperatures, therefore preventing the wort from caramelizing, scorching, or burning when applying high-power to reduce brewing time. The diffusion plate is integrated mechanically into a sturdy aluminum frame to safely support the weight of larger-than-normal batches of home-brewed beer and the brewing equipment, such as the brew pot and lid.

Power from a 2.2 KW electric stove burner, with an efficiency of 70%, is usually used to heat water when first learning to brew 5 gallons of normal gravity beer (OG=1.052) using extract-based malts. A couple of gallons of room temperature water, weighing approximately 16.68 lbs., are heated to a boiling temperature in about 25.68 minutes; the power source is turned off to prevent scorching, and then 5.9 lbs. of dried malt extract (DME) may be dissolved into the pot (6.5 lbs.) containing hot water. The heating time for the water and the weight of the pot and wort (29.08 lbs.) being heated on the stove are not unreasonable for the brewing setup.

Brewing 10-gallon or more batches of beer requires more power to maintain acceptable brewing times, whether using high-gravity extract or all-grain methods. Moreover, the total weight of 10 gallons of sparge water (83.4 lbs.) combined with a 15-gallon brew pot (14.5 lbs.) reaches 97.9 pounds, which poses a risk of mechanical damage to the stove. The above situation highlights the need for modifications to both the mechanical brewing system structure and the power level of the heating source in order to safely and effectively brew larger volumes of home-brewed beer more quickly and without damaging the brewing system. The BHP prototype, developed 17 years ago, utilized an aluminum or stainless-steel brew pot positioned directly on the burners. While the above design effectively heated the water, the above design may result in scorch marks on the bottom of the brew pot that correspond to the burner coils.

The above issue arose because the sugar in the wort often caramelized or nearly burned onto the thin base of the highly thermally conductive pot. Brewers must exercise particular caution when operating the burners at high settings, especially when introducing dried malt extract (DME) into the hot water above the burner coils, to avoid scorching the malty sugars on the pot's bottom. To address the above problem, the frame incorporates an additional diffusion plate intended to mitigate thermal hot spots on the brew pot's bottom surface. The plate distributes heat more uniformly across the plate's area and reduces the temperature to a level that prevents wort caramelization. The diffusion plate has an area of 380.19 square inches and a thickness of 0.75 inches.

Further, in some embodiments, the frame maybe constructed from four horizontal and two vertical aluminum C-channels. Further, the frame may include horizontal sections and vertical sections. Further, the horizontal sections measure 0.125 inches in thickness, 1 inch in width, 2 inches in height, and 27 inches in length. Further, the vertical sections have dimensions of 0.125 inches in thickness, 1 inch in width, 2 inches in height, and 12.25 inches in length. High-temperature oven wire was utilized, with the wiring secured using tie wraps, and no wire conduit was employed. The system incorporates three two-element 2.2 KW Calrod heaters and a diffusion plate. The input power cable is directly integrated into the control panel.

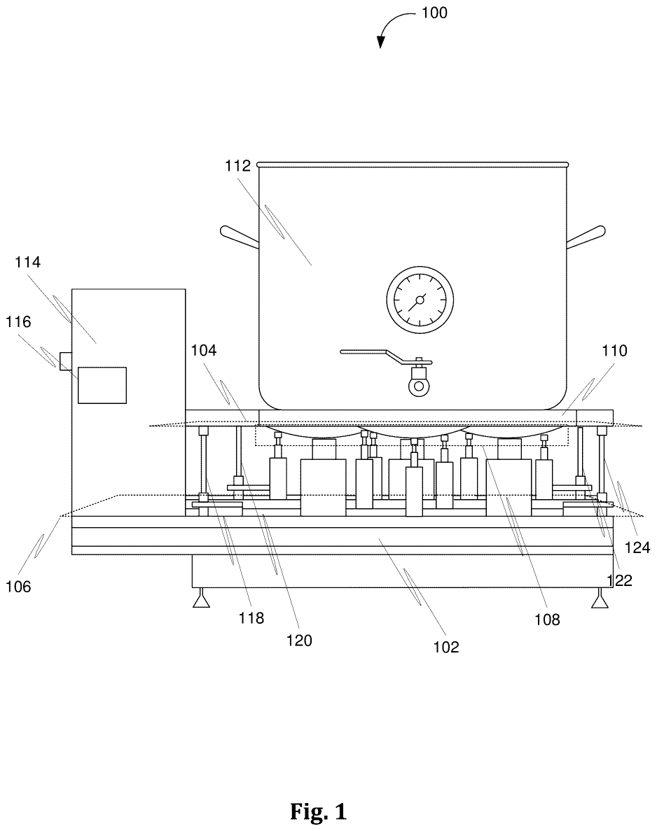

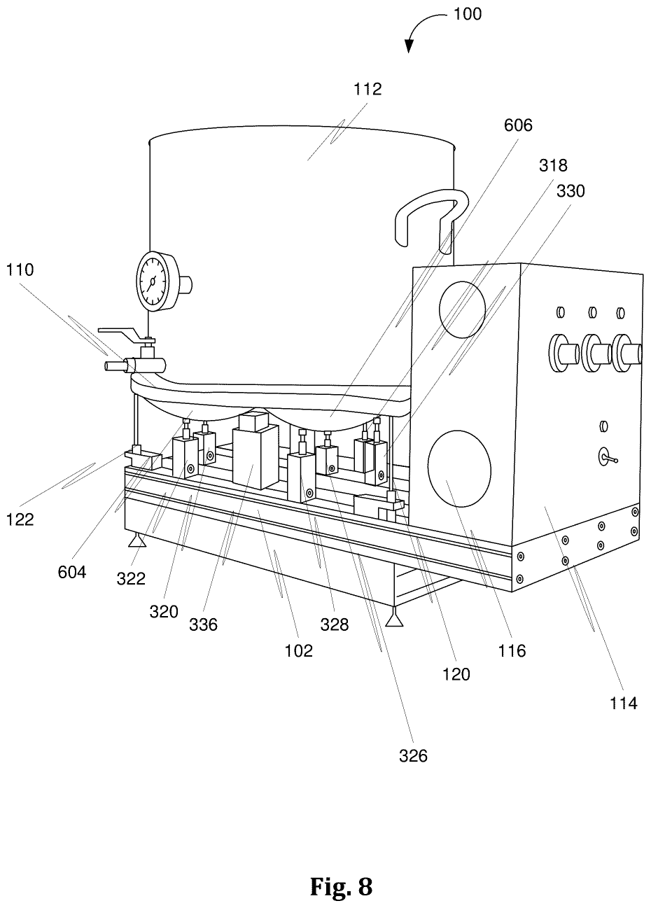

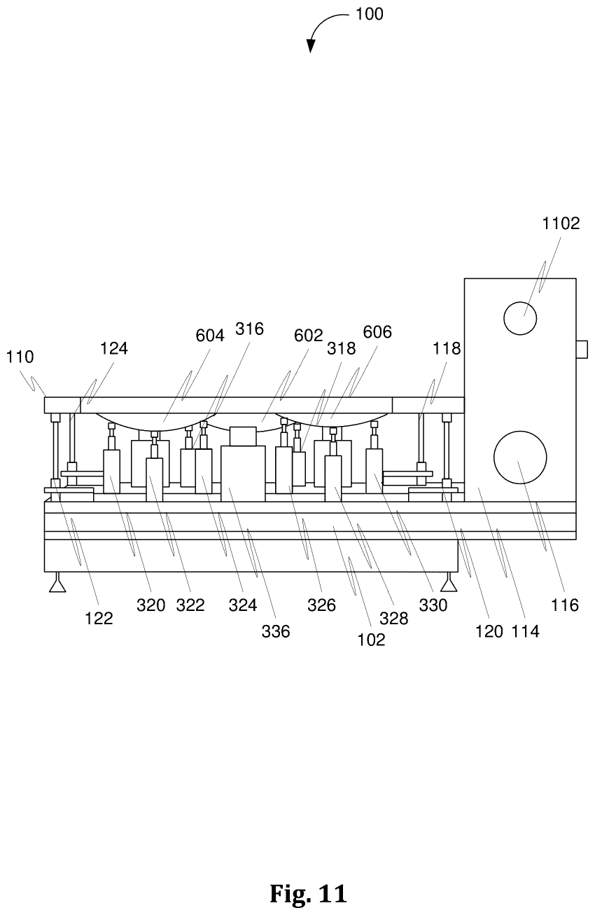

The control panel for the BHP prototype offers sixty-four power levels for the heaters, managed by six Single Pole Single Throw (SPST) 240 VAC switches. These switches provide power to three two-element Calrod burners, each equipped with both high (46 ohm) and low (59 ohm) power elements. The sixty-four power settings are adequate for effectively regulating the boiling rate of wort during the home brewing process. Additionally, incandescent lamps are wired across each heating element to indicate that power is being supplied to the heating components. The latest iteration, the second-generation brewing hotplate (BHP2), as depicted in FIG. 1, FIG. 8, and FIG. 11, features a durable and compact T-slot aluminum frame. The BHP2 incorporates an electrical-mechanical power control system with infinite switches, designed specifically for the efficient heating of water and wort during the homebrewing process. The BHP2 maintains the same plate and hole spacing dimensions as the predecessor, the BHP prototype. The BHP2 is equipped with standardized plug receptacles that allow for the connection of three interchangeable, field-repairable 2.2 KW Calrod heating burners (model WB30M2), delivering a combined output of 6.6 KW for operational efficiency. The diffusion plate is securely integrated into the robust aluminum frame, ensuring that the diffusion plate may safely support larger batches of homebrewed beer.

The objective of the present disclosure is to design a heating system for beer brewing that may withstand the heavy load of brewing equipment and liquids. Another goal is to decrease the total brewing duration in a single day while maintaining the beer's original flavor and body, albeit utilizing an elevated power level for heating sugary liquid. One objective of the present disclosure is to seamlessly incorporate a diffusion plate into the brew plate's frame structure, which may contribute to mechanical robustness and reduce the weight load experienced by the electrical burners.

An additional feature of the disclosed apparatus is the use of a diffusion plate's high thermal conductivity and capacity to absorb, store, and distribute heat more effectively, which contributes to the reduction of thermal hot spots across the diffusion plate's surface interfaces. Another purpose of the disclosed apparatus is to leverage efficient thermal conduction for heat transfer between the diffusion plate, heating elements, and brew pot, in conjunction with radiated heat transfer. The hotplate must be easy to assemble to reduce assembly costs and be reliable in use.

The completed BHP2 units incorporate a swivel leveling mount system, which is secured to the frame at four corners using a ¼-20 threaded stud and T-nut. The system delivers switchable Ground Fault Circuit Interrupter (GFCI)-protected power for pumps, lighting, and various other loads while effectively managing the power to the burners to control the energy supplied to the liquids in the brew pot during brewing.

Additionally, three incandescent lamps indicate when power is present across the burner coils. Mounted on the lower left-hand side of the enclosure is a flanged female inlet connector (CS6375L), rated for 50 A at 125/250V. The location was chosen to keep the heavy cable closer to the floor, which reduces the stress on the connector. The associated cable connector (CS6364L) has a male body, also rated for 50 A at 125/250V, and is compatible with flexible SOOW wire up to 8/3 gauge (40A). Both connectors include a 3-pole, 4-wire grounding configuration. Further, the two connectorized circuit assemblies may be linked via a 15-pin Molex connector.

Further, the flatness of the 0.75-inch-thick aluminum plate is 0.06 inches over a 22-inch by 22-inch area. The introduction of very cold water, approximately 50 degrees Fahrenheit, into the brew pot made a mechanical vibrating noise as the burners reached maximum power, indicating that the plate may have been warped or uneven over the 441 square inches of the brew pot's base. After milling the surface of the plate, the mechanical noise disappeared, even though the water used was colder than normal, and the burner controller was set to the highest heat setting. The flatness of the aluminum plate was measured at 0.002 inches or less over a 21-inch by 21-inch area.

Future aluminum plates must either meet stricter flatness specifications or be milled to ensure they are relatively flat, which may help reduce thermal resistance from conduction and decrease the temperature drop between the plate and the pot's bottom. The burner support assembly was constructed to guarantee that all components were aligned at an equal height on the top of the hotplate frame, ensuring that the frame beneath the burner remained as level as possible. With a weight of 27.76 lbs., the plate was placed on the three burners. Further, the diffusion plate was secured to the frame in four areas using the complete set of adjustable two-piece fasteners.

The BHP prototype was engineered to significantly mitigate the caramelization of wort, facilitating the art of home brewing high-gravity beers on larger scales. The BHP was constructed over 17 years ago, utilizing C-channel frames with drilled holes and slotted screws to attach the Calrod heater to the underside of the diffusion plate, which was incorporated into the aluminum frame. The disclosed heating apparatus addressed the challenge of bearing the weight of large volumes of water and wort at boiling temperatures. Simultaneously, the diffusion plate effectively stored and released heat, minimizing hot spots that could potentially burn or scorch sugary wort when subjected to elevated heating temperatures. The straightforward six-switch controller provided sufficient flexibility to maintain the heat at a consistent rolling boil without the risk of overflow. Over a span of 17 years, the BHP prototype experienced no electrical or mechanical failures.

The BHP2 was engineered to facilitate the mass assembly of the brewing hotplate and enhance mechanical support for greater weight capacity. The diffusion plate surfaces were precision-milled to within 3 mils, minimizing temperature gradients and optimizing efficient heat transfer through thermal conduction. The design of the electrical wiring was modified to include electrical metal tubing (conduit), allowing for improved heat dissipation and consequently lowering the temperature of the wires by connecting the EMT conduit to the BHP2 frame. The incorporation of an “infinite switch” allows for precise control over the heat of substantial volumes of boiling wort or water, ensuring a consistent rolling boil with high-temperature liquids.

To enhance the portability of the BHP2 with heavy power cables, inlet connectors have been integrated into the enclosure, ensuring that the cables are safeguarded from damage during both transportation and storage. The enclosure incorporates branch circuit breakers to enhance both safety and reliability. Additionally, a GFCI circuit receptacle, with a series switch, has been included to safeguard against electrical shock when operating a pump in damp environments. The BHP2 has many electrical, mechanical, and thermal improvements compared to the BHP listed in the present disclosure, and all of them have been reduced to practice.

Further, in some embodiments, a temperature controller may be used for managing solid-state relays. The Crydom D2425D Dual Solid-State Relay has been chosen to regulate power to the burners. High-speed cylindrical Fuses (Protistor) have been selected to protect the solid-state relay during overload conditions. The fuse rating is 690 VAC, 20 A, with dimensions of 10 mm×38 mm.

Further, the BHP and BHP2 were designed specifically for use in home brewing, where batches of beer up to 31 gallons or greater are achievable. The brewing system may prove to be very effective for heating thin-bottomed copper pots in home distilling scenarios, where substantial quantities of sugary liquid need to reach about 170° F. for alcohol evaporation.

Moreover, managing the risk of scorching the mash is a significant concern. Another application for the BHP2 is cooking sous vide, which involves cooking food at low temperatures for extended periods. In the cooking sous vide technique, food is sealed in a plastic pouch or glass jar and immersed in a water bath, allowing the food to cook at a carefully controlled temperature for longer than traditional cooking methods.

The disclosed embodiments in general relate to brewing hot plates and, more specifically, the disclosed embodiments relate to a kilowatt heating apparatus with a diffusion plate integrated within the frame for significantly reducing the caramelization or burning of sugary wort when subjected to high heat levels, thereby decreasing the total brewing time and improving the mechanical stability of the brewing system in large-scale home beer production.

An example embodiment of the disclosed apparatus is directed to a brewing hot plate which includes a frame, electric heaters, a diffusion plate, and a controller. In one embodiment, the disclosed apparatus provides a kilowatt heating apparatus with a diffusion plate integrated within the frame for significantly reducing the caramelization or burning of sugary wort when subjected to high heat levels, thereby decreasing the total brewing time and improving the mechanical stability of the brewing system in large-scale home beer production.

In one embodiment, the disclosed apparatus is a kilowatt heating apparatus with a diffusion plate integrated within the frame that is designed to optimize the method of heating water and wort during the brewing process. In one embodiment, the disclosed apparatus is a kilowatt heating apparatus with a diffusion plate integrated within the frame that may withstand the heavy weight of brewing equipment and liquids in excess of 250 lbs. In one embodiment, the disclosed apparatus is a kilowatt heating apparatus with a diffusion plate integrated within the frame that uses one or more resistive burner elements to heat the diffusion plate.

In one embodiment, the disclosed apparatus is a kilowatt heating apparatus with a diffusion plate integrated within the frame that has a built-in pump system to move hot liquids. In one embodiment, the disclosed apparatus is a kilowatt heating apparatus with a diffusion plate integrated within the frame that has a branch circuit breaker for each burner. In one embodiment, the disclosed apparatus is a kilowatt heating apparatus with the diffusion plate integrated within the frame that uses t-slotted profiles or C-channel to manufacture the frame. In one embodiment, the disclosed apparatus is a kilowatt heating apparatus with the diffusion plate integrated within the frame that has a diffusion plate with a surface flatness tolerance of 5 mils or less over 2 feet. In one embodiment, the disclosed apparatus is a kilowatt heating apparatus with the diffusion plate integrated within the frame that has an aluminum diffusion plate with high thermal conductivity.

In one embodiment, the disclosed apparatus is a kilowatt heating apparatus with the diffusion plate integrated within the frame that turns on lights to indicate power is delivered to the heating elements or the pump is on. In one embodiment, the disclosed apparatus is a kilowatt heating apparatus with the diffusion plate integrated within the frame that uses energy regulators (infinite switches) to control power to the burner elements.

In one embodiment, the disclosed apparatus is a kilowatt heating apparatus with the diffusion plate integrated within the frame that heats water and wort at higher-than-normal power levels to decrease heating time.

In one embodiment, the disclosed apparatus is a kilowatt heating apparatus with the diffusion plate integrated within the frame that heats wort at higher-than-normal power levels without caramelizing or burning sugars on the bottom of a pot. In one embodiment, the disclosed apparatus is a kilowatt heating apparatus with the diffusion plate integrated within the frame that reduces thermal hot spots across the bottom surface of a pot. In one embodiment, the disclosed apparatus is a kilowatt heating apparatus with the diffusion plate integrated within the frame that has a sufficient plate surface area to accept up to a 22-inch round brewing pot.

In one embodiment, the disclosed apparatus is a kilowatt heating apparatus with the diffusion plate integrated within the frame that has a diffusion plate with sufficient thermal mass to absorb, store, and distribute heat more effectively. In one embodiment, the disclosed apparatus is a kilowatt heating apparatus with the diffusion plate integrated within the frame that uses drip pans under the burners as heat shields to reduce wire temperatures.

In one embodiment, the disclosed apparatus is a kilowatt heating apparatus with the diffusion plate integrated within the frame that uses efficient thermal conduction heat transfer from the diffusion plate to the pot in conjunction with radiated heat. In one embodiment, the disclosed apparatus is a kilowatt heating apparatus with the diffusion plate integrated within the frame that provides a rolling boil that is effective in driving off Dimethyl Sulfide (DMS) from the wort.

In one embodiment, the disclosed apparatus is a kilowatt heating apparatus with the diffusion plate integrated within the frame that has adjustable burner supports. In one embodiment, the disclosed apparatus is a kilowatt heating apparatus with a diffusion plate integrated within the frame that has a fully assembled burner interface that consists of the bracket assembly, receptacle block, metal receptacle bracket, terminals, conduit, and burner.

A kilowatt heating apparatus with the diffusion plate integrated within the frame for significantly reducing the caramelization or burning of sugary wort when subjected to high heat levels, thereby decreasing the total brewing time and improving the mechanical stability of the brewing system in large-scale home beer production. The kilowatt heating apparatus with diffusion plate integrated within the frame generally includes a frame, electric heaters, the diffusion plate, and a controller.

Further, the present disclosure describes the following equations:
Power:

$$P = Cth ( Δ T ) / ( Δ t ) \qquad ( 1 )$$

Where:
   P=Power (W)
   Cth=Thermal capacity (J/° C.)
   ΔT=Change in temperature (° C.)
   Δt=Change in time (seconds)
Thermal Resistance (Conduction):

$$Rth ( Cond ) = Δ T / P \qquad ( 2 )$$

Where:
   Rth(Cond)=Thermal resistance due to thermal conduction (° C./W)
   P=Power (W)
   ΔT=Change in temperature (° C.)
Thermal Resistance (Convection):

$$Rth ( Conv ) = 1 / hA \qquad ( 3 )$$

Where:
   Rth(Conv)=Thermal resistance due to thermal convection (° C./W)
   A=Area (m²)
   h=Convective heat transfer coefficient (W/m²° C.)
Tau:

$$τ = 5 R thCth \qquad ( 4 )$$

Where:
   τ=Time constant
   Rth=Thermal resistance (° C./W)
   Cth=Thermal capacity (J/° C.)
Electrical Efficiency:

$$E = Pout / Pin \qquad ( 5 )$$

Where:
   Pin=Input power (W)
   Pout=Total power consumed by the load (W)
   E=Electrical Efficiency
Output Power:

$$Pout = PinE \qquad ( 6 )$$

Where:
   Pout=Total power consumed by the load (W)
   Pin=Input power (W)
   E=Electrical Efficiency
Thermal Resistance (Conduction-Solid Materials):

$$Rth ( conds ) = l / kA \qquad ( 7 )$$

Where:
   Rth=The thermal resistance (° C./W)
   l=The thickness of the material (m)
   k=The thermal conductivity of the material (W/m° C.)
Thermal Capacitance:

$$Cth = cpV \qquad ( 8 )$$

Where:
   Cth=Thermal capacity (J/° C.)
   V=Volume (cm)
   p=Density (g/cm)
   c=Heat capacity (J/g° C.)
Heating Time (Seconds)

$$s = mc ( Δ T ) / ( Δ P ) \qquad ( 9 )$$

Where:
   s=Time (seconds)
   m=Mass (g)
   c=Specific heat (J/g° C.)
   ΔT=Change in temperature (° C.)
   P=Power (W)
Heating Time (Minutes)

$$M = s / 60 \qquad ( 10 )$$

Where:
   M=Time (minutes)
   s=Time (seconds)
Power RMS (Electrical)

$$P = V {rms}^{2} / R \qquad ( 11 )$$

Where:
   P=Power (W)
   V rms=Voltage RMS (V rms)
   R=Resistance (Ohms)
Resistance (Ohm's Law):

$$R = Δ V / I \qquad ( 12 )$$

Where:
   I=Current (A)
   ΔV=Voltage difference across the resistance R(V)
   R=Resistance (Ohms)

In some embodiments, the disclosed apparatus inherently improves thermal energy distribution technology by integrating a diffusion plate directly into a structural frame, which may address the technical problem of localized thermal concentration caused by point-source electric heaters. In such embodiments, conventional heating systems may suffer from uneven heat flux that leads to scorching or caramelization when heating sugar-containing liquids. The integrated diffusion plate may be implemented as a thick, high thermal-conductivity metal body that spreads thermal energy laterally through solid-state thermal conduction before transferring heat upward. In some embodiments, the diffusion plate may be formed from aluminum, copper, or laminated metal composites, each providing different conduction profiles. In some embodiments, the diffusion plate may be mechanically fixed at multiple frame attachment points to maintain precise geometric alignment, thereby improving the technology of high-power resistive heating by enabling uniform surface temperature at power densities that would otherwise be impractical.

In some embodiments, the disclosed apparatus inherently improves mechanical load management technology in a heated apparatus by redistributing vertical load paths away from the heater and into the frame via the diffusion plate. In such embodiments, a technical problem exists wherein heating elements are mechanically stressed by heavy containers placed directly above them. The diffusion plate, when integrated as a structural element, may act as a load-bearing member that transfers compressive force into the frame rather than into the heater. The mechanical management technology may be implemented through corner-mounted fasteners, perimeter flanges, or embedded support ribs, each example allowing the diffusion plate to carry static and dynamic loads. This feature may improve the technology of electrically heated platforms by decoupling thermal generation from mechanical support.

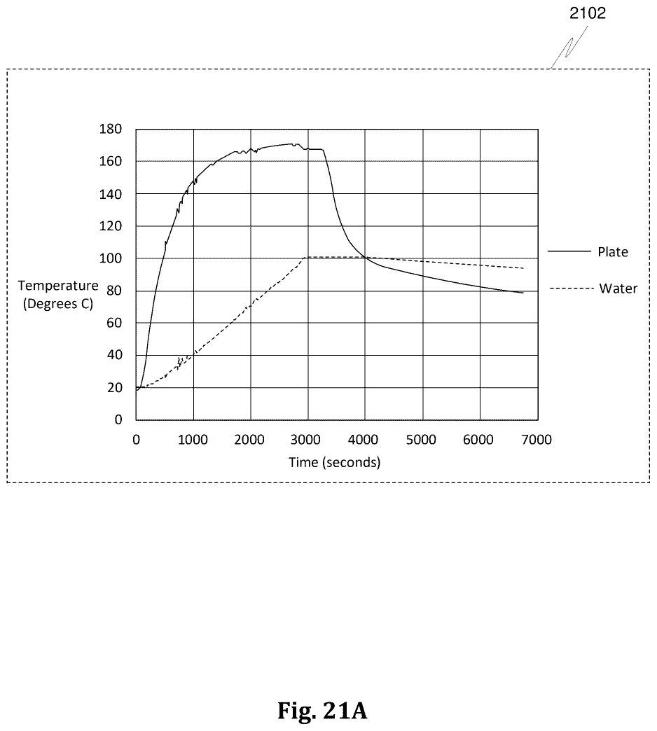

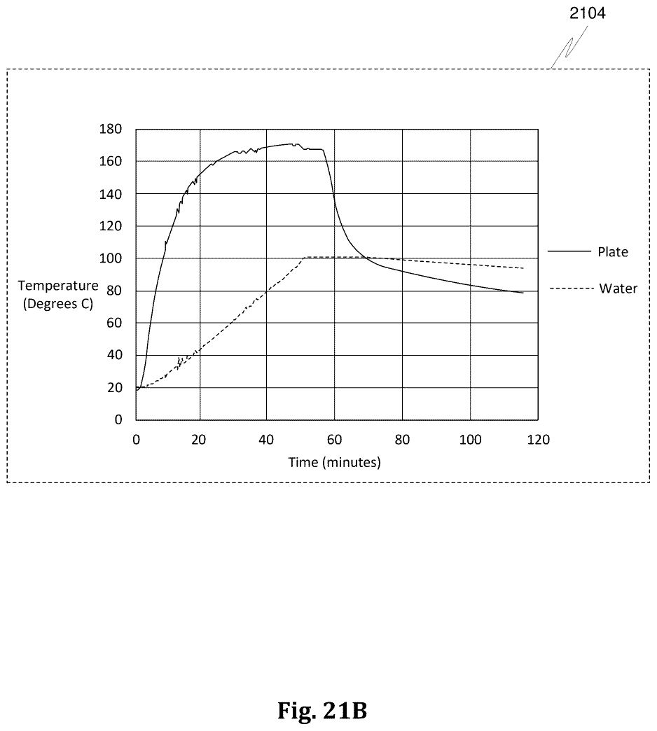

In some embodiments, the disclosed apparatus may inherently improve thermal interface technology by reducing interfacial thermal resistance between a heated surface and a container. A technical problem addressed, in the non-linearity of heating at high temperature change with respect to time, shown in the thermal modeling, may be the presence of microscopic air gaps caused by surface irregularities, as defined in FIG. 21A and FIG. 21B. The diffusion plate may be machined, ground, or surface-treated to achieve high flatness and surface finish, thereby minimizing air entrapment. In some embodiments, the diffusion plate may include surface texturing that enhances conductive contact. The disclosed apparatus may improve the technology of conductive heat transfer by enabling lower plate temperatures for a given heat flux.

In some embodiments, the disclosed apparatus inherently improves transient thermal response technology by leveraging the thermal capacitance of the diffusion plate. A technical problem may arise from rapid heater cycling using solid state switches that produce unstable temperature profiles. The diffusion plate may absorb excess heat during transient spikes and release stored heat during power reductions. The transient thermal response technology may be implemented by varying plate volume (area×thickness), density of the plate material, or heat capacity of the plate material. Further, as defined in equation (8), voids in the diffusion plate may have an inverse effect on thermal resistance due to thermal conditions. Further, the transient thermal response technology feature may improve thermal buffering technology in high-power heating systems.

In some embodiments, the disclosed apparatus inherently improves scalability technology for high-power heating by enabling uniform heating over large surface areas.

In some embodiments, the disclosed apparatus inherently improves safety technology by isolating high-temperature components from electrical control components. The frame may spatially separate the diffusion plate and heater from a controller enclosure. The safety technology may be implemented with dedicated mounting planes or thermal barriers. The disclosed apparatus may improve electrical safety in high-power devices.

In some embodiments, the disclosed apparatus inherently improves energy utilization technology by combining conductive and radiative heat transfer modes through the diffusion plate. The plate may receive radiated heat from the heater and drip pan (heat shield) and redistribute the radiated heat conductively to the plate (increasing system efficiency). The hybrid transfer approach may be implemented through surface coatings or controlled emissivity. The disclosed apparatus may improve thermal transfer efficiency technology.

In some embodiments, the disclosed apparatus inherently improves process stability technology by enabling consistent rolling boil conditions without localized overheating. The diffusion plate may maintain uniform temperature gradients across the container interface. The disclosed apparatus may improve thermal process control technology in liquid heating applications.

In some embodiments, additional technical improvements may be incorporated to further enhance performance. One or more temperature sensors may be embedded within the plate body to directly measure plate temperature at multiple locations to regulate and control plate temperature. The disclosed apparatus may improve temperature monitoring technology by providing real-time thermal state data. Further, the one or more temperature sensors may be used to measure liquid temperature in home brewing.

Further, in some embodiments, the one or more sensors may include one or more first sensors configured for monitoring and controlling the temperature of the mash in the mash tun using one or more of a RIMS process and temperature step process.

Further, in some embodiments, the one or more sensors may include one or more second sensors configured for monitoring and controlling the temperature of wort in the brew pot for preventing boil overs and maintaining a rolling boil.

In some embodiments, the disclosed apparatus may include advanced surface engineering technology to address fouling or residue buildup. The diffusion plate may include non-stick or corrosion-resistant coatings that withstand high temperatures. The disclosed apparatus may improve surface durability technology. Further, the diffusion plate includes temperature-resistant fluoropolymer material coating, such as polytetrafluoroethylene (PTFE or Teflon), capable of withstanding the temperature of the diffusion plate. Further, prior identification of suitable coatings demonstrated that application necessitates off-site coating, thereby introducing manufacturing inefficiencies. Further, the temperature-resistant fluoropolymer material coating may provide a functional advantage by reducing adhesion of wort residues to the heated diffusion plate surface, thereby facilitating removal of burnt deposits resulting from spillage during operation.

In some embodiments, the disclosed apparatus may include modular frame technology to address configurability limitations. The frame may include standardized attachment interfaces that allow repositioning or replacement of the diffusion plate. The disclosed apparatus may improve modular mechanical system technology.

In brewing applications, the fundamental thermal objective is the controlled heating of water, wort, and grain to specific target temperatures and heating rates that directly affect enzyme activity, mash efficiency, boil vigor, flavor development, and removal of undesirable compounds. The temperature of the liquid, rather than the temperature of any intermediate heating structure, is the primary variable of interest to the brewer. The disclosed heating apparatus is therefore designed and evaluated with liquid temperature as the governing performance metric. In some embodiments, the heating apparatus includes a rigid frame that supports a container holding water or wort, one or more electric heaters mounted beneath the container, a diffusion plate positioned between the heaters and the container, and a controller that regulates electrical power supplied to the heaters. The system is configured to deliver high thermal power to the liquid while maintaining uniform heat distribution across the container bottom.

The diffusion plate functions as an intermediate thermal element that spreads heat laterally before the heat enters the container. This arrangement allows the system to apply higher-than-normal heater power without causing localized overheating of the liquid, particularly in brewing scenarios involving sugar-rich wort that is susceptible to caramelization or scorching.

Role of Liquid Temperature in Brewing Operation: In some embodiments, operation of the heating apparatus is governed by observation and control of water or wort temperature. During brewing processes such as heating strike water, raising mash temperature, or maintaining a rolling boil, the brewer adjusts heater power based on the temperature and behavior of the liquid. The heating apparatus is configured to respond predictably to the adjustments by delivering stable and evenly distributed heat into the container.

The diffusion plate enables the brewer to apply increased heater power during heating phases without creating localized hot spots at the container interface. As a result, the liquid temperature rises in a controlled and repeatable manner, reducing the risk of burning sugars or damaging the wort even under high thermal input.

Plate Temperature Measurement for Engineering Validation: In some embodiments, the temperature of the diffusion plate is measured during development, testing, and validation of the heating apparatus. Plate temperature measurement is not used as a primary control variable during brewing operation, but serves as an engineering parameter for understanding system behavior.

In some embodiments, thermocouples are attached to or embedded in the diffusion plate to measure plate temperature over time while simultaneously measuring water or wort temperature. The above measurements are used to correlate the thermal performance of the physical system with analytical or circuit-based thermal models. By observing the relationship between plate temperature and liquid temperature, the designer is able to characterize heat transfer efficiency, thermal resistance at interfaces, and the transient response of the system.

The measured plate temperature data may also be used to identify a maximum operating plate temperature under worst-case heating conditions. The above information supports the selection of suitable surface finishes, coatings, or treatments for the diffusion plate that can withstand sustained high temperatures without degradation. The plate temperature thus provides a design constraint rather than an operational control target.

Thermal Behavior and Heat Transfer: In some embodiments, when power is applied to the heaters, the diffusion plate absorbs heat and its temperature rises before heat is transferred into the container and liquid. This warm-up phase allows the diffusion plate to store thermal energy and establish a uniform temperature profile across its surface. Once the liquid reaches boiling temperature, continued heat input maintains a stable rolling boil without requiring excessive heater temperature.

The diffusion plate reduces temperature gradients at the container interface, allowing efficient transfer of thermal energy into the liquid while keeping the heater and plate temperatures lower than would be required in systems without such a plate. This behavior improves system efficiency and protects both the liquid and system components from thermal damage.

Brewing-Relevant Performance Outcomes: In some embodiments, the heating apparatus provides a rolling boil sufficient to drive off volatile compounds such as dimethyl sulfide from the wort without inducing boil-over or scorching. The uniform heat distribution enabled by the diffusion plate allows the brewer to operate at higher total power levels while maintaining fine control over boil intensity through the controller.

In some embodiments, the mechanical integration of the diffusion plate into the frame allows the apparatus to support large containers and significant liquid volumes without transferring mechanical load to the heaters. This improves reliability during brewing operations that involve frequent handling, stirring, or pumping of hot liquids.

From a brewing perspective, the disclosed heating apparatus is fundamentally a liquid-heating system optimized for uniform, high-power thermal input. The brewer interacts with the system based on liquid temperature and behavior, while plate temperature serves as an internal engineering parameter used during design, modeling, and materials selection. This separation of operational control and engineering validation allows the apparatus to deliver improved brewing performance while maintaining predictable and robust thermal behavior.

The BHP addresses the brewing problems such as inconsistent brewing temperature, uneven heat distribution, a long heating time, safety hazards, and difficulty in cleaning and maintenance.

The disclosed apparatus exhibits a non-linear temperature rise on the heating plate, which results from air gaps inherent in the assembled geometry of the brewing hot plate. This thermal behavior constitutes a defining mechanism of the system, as the rate of temperature increase under high-power operation (dT/dt). Further, the disclosed apparatus may not be reproduced or function as intended without the occurrence of the above mechanism.

Further, the disclosed apparatus may support and press the Calrod burner against the underside of the plate, using the y-frame attached to the bottom of the burner, to minimize the thermal conduction resistance due to the air gap between the burner and the bottom of the plate. Further, the adjustable slotted screws mounted to the frame add burner support from the frame as well as supporting excessive weight due to the excessive water weight, so the 4 mounting screws attaching the plate support only a fraction of the weight during the brewing process.

Further, the resistive burner may be replaced with a pancake coil, which generates a varying high-frequency magnetic field around the coil. Further, the given field effectively induces Eddy currents in the ferrous material of the diffusion plate, producing heat within the plate. Further, the given heating technique heats the diffusion plate without any physical contact between the heating coil and the diffusion plate's bottom, utilizing a high-frequency capacitor discharge circuit.

There is no conventional apparatus without the use of the diffusion plate to mitigate hot spots from the burners, and the plate is integrated into the frame. The diffusion plate solves the problem of caramelization of sugary wort and changing the flavor of the beer, facilitating the making of better beer in a shorter amount of time.

The frequency of the capacitor discharge circuit is optimized for “through or partial heating” of the diffusion plate using steel or ferritic stainless steels (magnetic AISI 430 and AISI 410, relative permeability=200-500 at 200° C. operation temperature).

Further, in some embodiments, the diffusion plate may be manufactured for inductive heating applications with a thinner bottom plate (ferritic stainless steels) and a thicker non-ferrous material attached or bonded to the bottom plate for heat spreading, thus removing hot spot temperatures. Further, the thinner material allows for higher control frequency operation that reduces the size and weight of the capacitor discharge circuit.

A PID temperature controller may be used to manage solid-state relays. A PID controller, or Proportional-Integral-Derivative controller, may be a feedback control mechanism widely used in industrial applications to regulate variables like temperature, pressure, and speed. The PID temperature controller continuously adjusts the output based on the difference between a desired setpoint and the measured process variable to minimize error and maintain stability. The Crydom D2425D Dual Solid-State Relay may have been chosen to regulate power to the burners. High-Speed Cylindrical Fuses (Protistor) have been selected to protect the solid-state relay during overload conditions. The fuse rating is 690 VAC, 20 A, with dimensions of 10 mm×38 mm.

Further, the disclosed heating apparatus may include a proximity sensor with a power latching circuit. The sensor senses if a pot is on the diffusion plate. The power is turned off to the heaters if no pot is on the diffusion plate. A pot needs to be on the plate to turn on the power.

Key aspects of the disclosed heating apparatus:
1. Use of a diffusion plate to mitigate thermal hot spots, caramelization, and burning of sugar on the bottom of the brew pot.
2. Integration of diffusion plate into the frame to support heavier than normal weight loads and mitigate thermal hot spots, caramelization (work in concert with each other).
3. Milling the plate for a surface flatness tolerance of 5 mil-inches or less over 2 feet stop mechanical chattering between the brew pot filled with cold water and the diffusion plate.
4. BHP2 allows home brewers to brew larger than normal batches of beer; can brew 30 gallons or greater rather than 5-10 gallons.
5. The integration of a GFCI breaker to safely provide power to a food grade pump to safely move hot liquids.
6. Integration of a pump to move hot liquids (100° C.).
7. The thermal capacitance of the diffusion plate improves (averages) the change in temperature rise in the wort using a PID controller and solid-state relays. The Recirculating Infusion Mash System (RIMS) method needs to recirculate wort from the infusion mash tun (combination mash and lauter vessel) continuously during mashing to move the wort through an in-line heater. In this case, the BHP is the in-line heater.

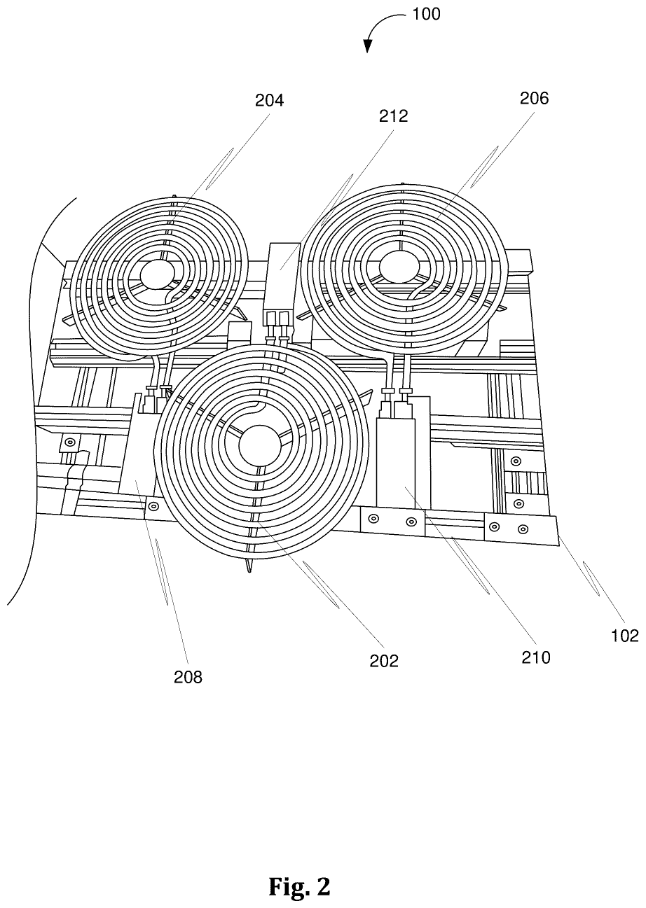

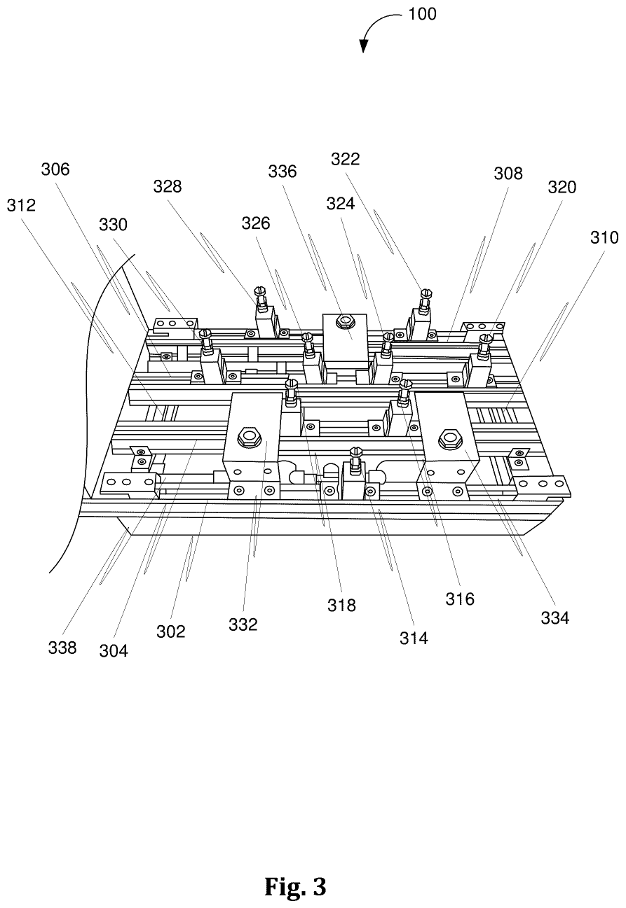

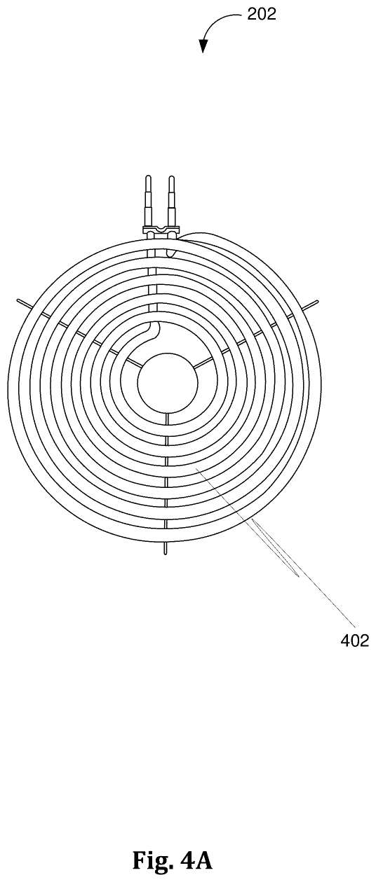

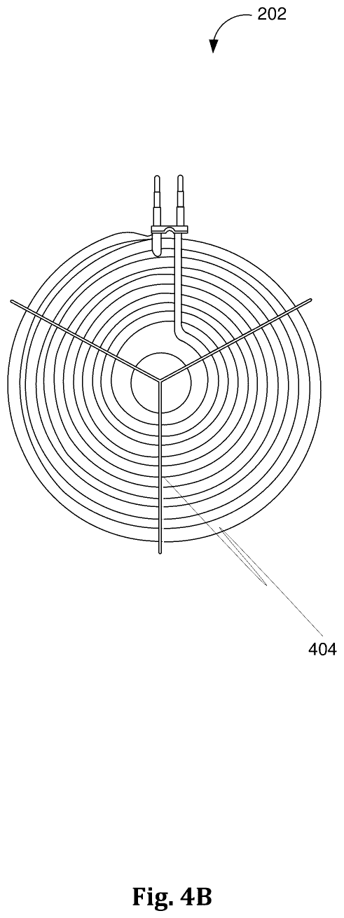

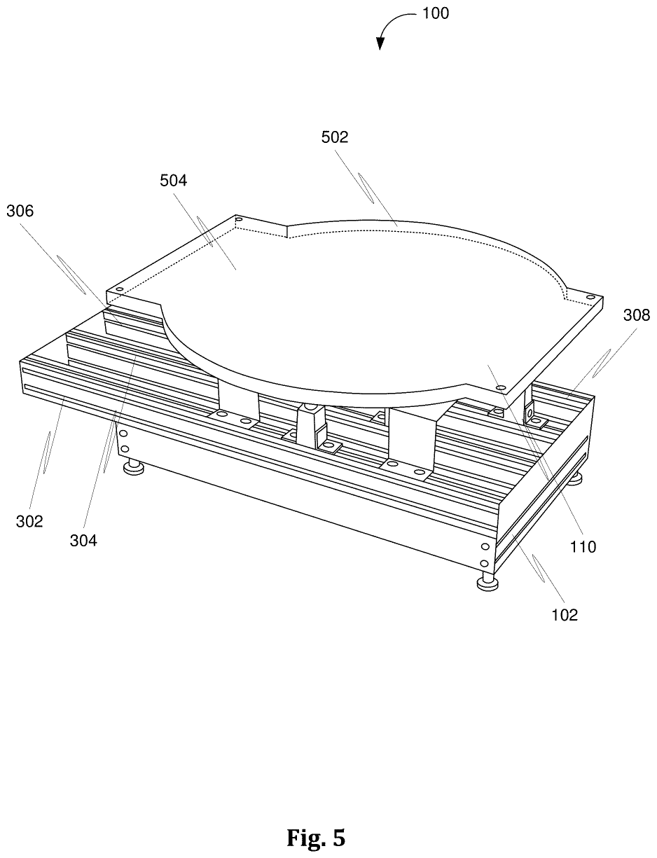

FIG. 1 illustrates a front view of a heating apparatus 100 for facilitating uniform high-power heating of liquid, in accordance with some embodiments. Further, the heating apparatus 100 may include a frame 102 comprising a rigid elongated body formed from two or more horizontal members (302-308) and two or more vertical members (310-312), as shown in FIG. 3, joined to define an open structure having an upper plane 104 and a lower plane 106. Further, the frame 102 may be configured for supporting a load above the upper plane 104. Further, the heating apparatus 100 may include a heater 108 comprising one or more heating elements (202-206), as shown in FIG. 2, formed as a continuous metal coil having an upper heat-emitting surface 402 and a lower mounting surface 404, as shown in FIGS. 4A and 4B. Further, the heater 108 may be mechanically attached to the frame 102. Further, the upper heat-emitting surface 402 of the heater 108 may be oriented upward. Further, the heater 108 may be configured for generating heat. Further, the heating apparatus 100 may include a diffusion plate 110 comprising a solid planar metal body having a flat upper surface 502 and a flat lower surface 504, as shown in FIG. 5. Further, the diffusion plate 110 may be positioned above the heater 108. Further, the diffusion plate 110 may be mechanically integrated with the frame 102. Further, the flat lower surface 504 of the diffusion plate 110 faces the upper heat-emitting surface 402 of the heater 108 to receive heat from the upper heat-emitting surface 402. Further, the flat upper surface 502 of the diffusion plate 110 may be configured for direct contact with a bottom surface of a container 112 containing the liquid. Further, the flat upper surface 502 may be configured for transferring the heat to the bottom surface of the container 112 uniformly to reduce one or more of caramelization of sugar in the liquid and burning of the sugar in the liquid on the bottom surface of the container 112. Further, the heating apparatus 100 may include a controller 114 electrically connected to the heater 108. Further, the controller 114 may be configured for regulating an electrical power supplied to the heater 108 to control the generating of the heat. Further, the heating apparatus 100 may include a power terminal 116 configured to receive the electrical power. Further, the power terminal 116 may be electrically coupled to each of the heater 108 and the controller 114.

FIG. 2 illustrates a top view of the heating apparatus 100 in absence of the diffusion plate 110 for facilitating uniform high-power heating of liquid, in accordance with some embodiments. Further, FIG. 2 shows the one or more heating elements (202-206) of the heating apparatus 100.

FIG. 3 illustrates a top view of the heating apparatus 100 in absence of the diffusion plate 110 and the one or more heating elements (202-206) for facilitating uniform high-power heating of liquid, in accordance with some embodiments. Further, FIG. 3 shows the two or more horizontal members (302-308) and two or more vertical members (310-312) of the frame 102.

FIGS. 4A and 4B illustrate a first heating element 202 of the heating apparatus 100 for facilitating uniform high-power heating of liquid, in accordance with some embodiments. Further, FIG. 4A shows the upper heat-emitting surface 402 of the one or more heating elements (202-206), and FIG. 4B shows the lower mounting surface 404 of the one or more heating elements (202-206).

FIG. 5 illustrates the frame 102 and diffusion plate 110 of the heating apparatus 100 for facilitating uniform high-power heating of liquid, in accordance with some embodiments. Further, FIG. 5 shows the flat upper surface 502 of the diffusion plate 110 and the flat lower surface 504 of the diffusion plate 110.

In some embodiments, the one or more heating elements (202-206) may include a resistive heating element. Further, the resistive heating element may be configured for converting an electrical energy into the heat. Further, the generating of the heat comprises the converting of the electrical energy into the heat.

In some embodiments, the liquid comprises a sugary wort. Further, the uniform high-power heating of the liquid comprises uniform high-power heating of the sugary wort associated with a brewing process. Further, the reducing of at least one of the caramelization of the sugar in the liquid and the burning of the sugar in the liquid may facilitate reducing a total brewing time of the brewing process.

In some embodiments, the diffusion plate 110 may include non-ferrous aluminum material.

In some embodiments, the one or more heating elements (202-206) may include an induction coil. Further, the induction coil may be configured for generating an electromagnetic field to induce the heat in the diffusion plate 110. Further, the diffusion plate 110 may be made of a ferrous material. Further, the generating of the heat comprises the generating of the electromagnetic field to generate eddy currents in the diffusion plate 110 material to induce heat in the diffusion plate 110.

In some embodiments, the solid planar metal body of the diffusion plate 110 includes a monolithic metal plate body having a continuous internal volume. Further, the monolithic metal plate body may be formed from a material exhibiting high thermal conductivity. Further, the heat received from the upper heat-emitting surface 402 at a localized region on the flat lower surface 504 spreads laterally across the continuous internal volume before the heat reaches the flat upper surface 502. Further, the reducing of one or more of the caramelization of the sugar in the liquid and the burning of the sugar in the liquid may be based on spreading the heat laterally across the continuous internal volume before the heat reaches the flat upper surface 502. Further, the transferring of the heat to the bottom surface may be based on the reaching of the flat upper surface 502 by the heat.

In some embodiments, the diffusion plate 110 may be configured to optimize a process of heating during the brewing process by spreading the heat laterally across the continuous internal volume before the heat reaches the flat upper surface 502.

In some embodiments, the liquid further comprises water. Further, the process of heating comprises a process of heating one or more of the water and the sugary wort.

In some embodiments, the frame 102 may be configured to support the load greater than 250 lbs.

In some embodiments, the process of heating one or more of the water and the sugary wort comprises a process of heating one or more of the water and the sugary wort at a higher-than-normal power level to reduce a heating time of the brewing process.

In some embodiments, the process of heating one or more of the water and the sugary wort comprises a process of heating the sugary wort at a higher-than-normal power level without one or more of caramelization and the burning of the sugary wort at a bottom of the container 112.

In some embodiments, the diffusion plate 110 may have a predetermined thickness measured between the flat upper surface 502 and the flat lower surface 504. Further, the predetermined thickness of the diffusion plate 110 defines a thermal mass which may be configured to perform an absorption of the heat from the upper heat-emitting surface 402 and temporarily storing the heat prior to the transferring of the heat energy to the bottom surface of the container 112. Further, the predetermined thickness of the diffusion plate 110 ranges from 0.5 inch to 1 inch.

In some embodiments, the diffusion plate 110 may be mechanically integrated with the frame 102 by two or more fixed attachments at two or more spaced locations along a perimeter of the diffusion plate 110. Further, the two or more spaced locations may be configured to transfer the load from the diffusion plate 110 directly into the frame 102. Further, the frame 102 integrated with the diffusion plate 110 may be configured for supporting a load exceeding 250 lbs. Further, the supporting of the load exceeding 250 lbs comprises supporting the container 112 containing the liquid with a quantity of 30 gallons.

In some embodiments, the flat upper surface 502 of the diffusion plate 110 may be machined to a substantially flat planar geometry over an area corresponding to the bottom surface of the container 112 to reduce an air gap at an interface between the diffusion plate 110 and the container 112. Further, the diffusion plate 110 may be characterized by a maximum surface flatness tolerance of 5 mils across a span of 2 feet. Further, the maximum surface flatness tolerance may prevent a mechanical chattering between the container 112 containing the liquid and the diffusion plate 110.

In some embodiments, the diffusion plate 110 may be arranged as a physical barrier positioned between the heater 108 and the container 112. Further, the receiving of the heat from the upper heat-emitting surface 402 includes receiving the heat by conduction and/or radiation. Further, the transferring of the heat to the bottom surface of the container 112 is further based on the receiving of the heat by conduction and/or radiation.

Further, in some embodiments, the heat may include one or more of a radiant heat and a conductive heat.

In some embodiments, the diffusion plate 110 may intercept a radiant heat emitted upward from the upper heat-emitting surface 402 of the heater 108 before the radiant heat reaches the bottom surface of the container 112. Further, the transferring of the heat to the bottom surface of the container 112 comprises transferring the radiant heat to the bottom surface of the container 112.

In some embodiments, the diffusion plate 110 may be configured for receiving the heat from the upper heat-emitting surface 402 at a power level sufficient to raise a temperature of the diffusion plate 110 above a boiling temperature of the liquid by maintaining a distributed temperature profile across the flat upper surface 502. Further, the container 112 contains the liquid.

In some embodiments, the frame 102 defines a fixed mounting geometry constraining the diffusion plate 110 at a predetermined vertical spacing relative to the heater 108 to maintain consistent alignment between the heater 108 and the diffusion plate 110 during an operation. Further, the operation includes converting the electrical energy into the heat, receiving the heat from the upper heat-emitting surface 402, and transferring the heat to the bottom surface of the container 112.

In some embodiments, the liquid may include sugary wort. Further, a thermal capacitance of the diffusion plate 110 regulates a change in a temperature of the sugary wort. Further, the thermal capacitance of the diffusion plate 110 is the absorption of the heat by the diffusion plate 110 and the storing of the heat in the diffusion plate 110. Further, the controller 114 may include a proportional-integral-derivative (PID) temperature controller coupled with the diffusion plate. Further, the controller 114 further may include a solid-state relay and a mechanical relay coupled with the PID temperature controller. Further, the PID temperature controller is configured to determine a quantity of the electrical power to be supplied to the heater 108 based on a temperature of the diffusion plate and the temperature of the sugary wort. Further, the regulating of the electrical power supplied to the heater 108 comprises regulating the electrical power supplied to the heater 108 using the solid-state relay based on the determining of the quantity of the electrical power.

In some embodiments, the flat upper surface 502 of the diffusion plate 110 may be characterized by a first surface area. Further, the upper heat-emitting surface 402 of the heater 108 may be characterized by a second surface area. Further, the first surface area may be greater than the second surface area for allowing the heat to spread over an expanded area before the transferring of the heat to the bottom surface of the container 112.

In some embodiments, the container 112 may be characterized by a circular base comprising a diameter of 22 inches. Further, the first surface area of the diffusion plate 110 may be configured to accommodate the container 112 comprising the circular base with the diameter of 22 inches.

In some embodiments, the diffusion plate 110 may be configured to reduce a peak surface temperature of the heater 108 by the receiving of the heat from the upper heat-emitting surface 402 and the spreading of the heat laterally across the continuous internal volume.

In some embodiments, the liquid comprises sugary wort. Further, a thermal capacitance of the diffusion plate regulates a change in temperature of the sugary wort. Further, the thermal capacitance of the diffusion plate may be the absorption of the heat by the diffusion plate 110 and the storing of the heat in the diffusion plate 110. Further, the controller 114 comprises a PID temperature controller coupled with the diffusion plate 110 and a solid-state relay. Further, the PID temperature controller may be configured to determine a quantity of the electrical power needed to be supplied to the heater 108 based on a temperature of the diffusion plate 110. Further, the regulating of the electrical power supplied to the heater 108 comprises regulating the electrical power supplied to the heater 108 using the solid-state relay based on the determining of the quantity of the electrical power.

In some embodiments, the diffusion plate 110 may be configured to reduce a thermal hot spot across the bottom surface of the container 112 by performing one or more of the receiving of the heat from the upper heat-emitting surface 402 of the heater 108 and the spreading of the heat laterally across the continuous internal volume of the diffusion plate before the heat reaches the flat upper surface 502. Further, the reducing of one or more of the caramelization of the sugar in the liquid and the burning of the sugar in the liquid may be based on the reducing of the thermal hot spot of the container.

In some embodiments, the reducing of the thermal hot spot across the bottom surface of the container 112 may reduce a flavor change of a beer.

In some embodiments, the two or more horizontal members (302-308) and the two or more vertical members (310 and 312) include two or more elongated structural members. Further, the two or more elongated structural members define an open interior volume beneath the diffusion plate 110. Further, the two or more elongated structural members may be arranged to form a rigid load-bearing geometry supporting the diffusion plate 110 by leaving the heater 108 exposed to an ambient air for convective cooling.

Further, in some embodiments, the drip pan (302-306) may aid in gaining back some efficiency of one or more burners associated with the heating apparatus 100 by reflecting one or more portions of the radiated energy from the one or more burners to the underside of the diffusion plate 110.

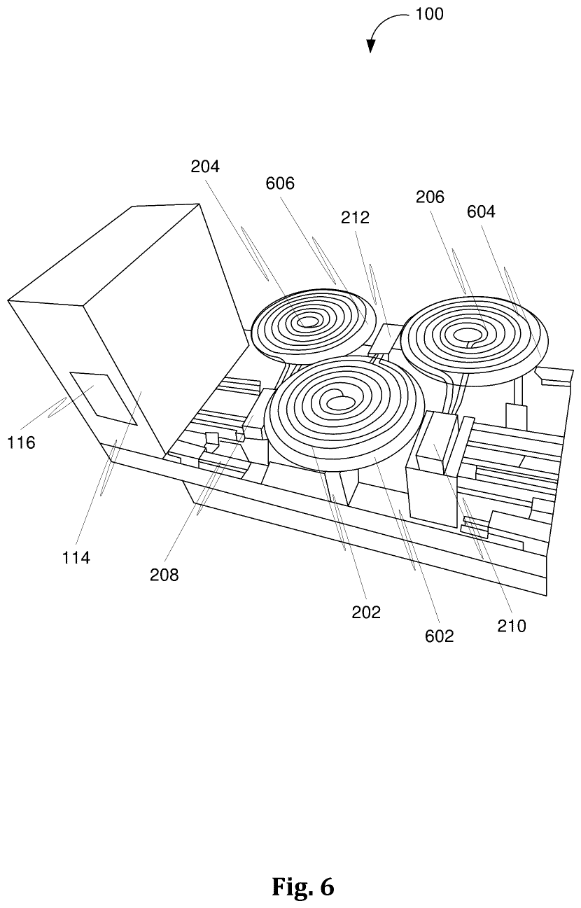

FIG. 6 illustrates a perspective view of the heating apparatus 100 for facilitating uniform high-power heating of liquid, in accordance with some embodiments. Further, the heater 108 includes one or more thermal shields (602-606) formed as a continuous curved metal element. Further, the one or more thermal shields (602-606) may be secured to a mounting surface of the frame 102. Further, the continuous curved metal element defines a distributed heat-emission profile directed toward the flat lower surface 504 of the diffusion plate 110. Further, FIG. 6 shows the one or more thermal shields (602-606) in an absence of the diffusion plate 110.

In some embodiments, the diffusion plate 110 may be mechanically integrated with the frame 102 at two or more discrete corner regions using two or more mechanical fasteners (118-124), as shown in FIG. 1, extending through the diffusion plate 110 and into the frame 102. Further, the two or more mechanical fasteners (118-124) may be positioned to suspend a central region of the diffusion plate 110 above the heater 108.

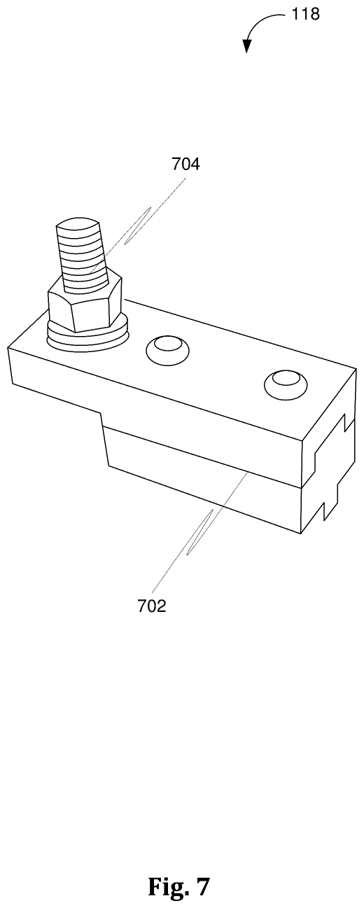

FIG. 7 illustrates a mechanical fastener 118 of the heating apparatus 100 for facilitating uniform high-power heating of liquid, in accordance with some embodiments. Further, the mechanical fastener 118 comprises a fastener base 702 and a threaded shaft 704. Further, the threaded shaft 704 may be coupled to the fastener base 702.

In some embodiments, the solid planar metal body includes an aluminum plate body. Further, the aluminum plate body may be characterized by a thickness sufficient to resist an elastic deformation of the diffusion plate 110 during high thermal excursion from the heater 108 and under the load applied by the container 112 to maintain a surface flatness of the diffusion plate 110 during the heating of the liquid.

In some embodiments, the solid planar metal body may be configured to improve a mechanical stability of the apparatus in a large-scale home beer production. Further, the heating apparatus 100 may be a brewing system.

In some embodiments, the aluminum plate body may be characterized by high thermal conductivity.

In some embodiments, the controller 114 includes a rigid enclosure. Further, the rigid enclosure may be attached to an exterior surface of the frame 102. Further, the rigid enclosure defines an internal cavity physically isolating an electrical control circuitry from the heat generated by the heater 108. Further, the controller 114 comprises the electrical control circuitry.

FIG. 8 illustrates a perspective view of the heating apparatus 100 for facilitating uniform high-power heating of liquid, in accordance with some embodiments. Further, FIG. 8 shows the power terminal 116 of the heating apparatus 100.

In some embodiments, the frame 102 may include two or more adjustable support members (314-330), as shown in FIG. 3, mounted on a top of the two or more horizontal members (302-308) and positioned beneath the one or more heating elements (202-206). Further, the two or more adjustable support members (314-330) comprise two or more slotted headed screws configured to support a mounting frame of the one or more heating elements (202-206). Further, the lower mounting surface 504 of the one or more heating elements (202-206) comprises the mounting frame. Further, the two or more adjustable support members (314-330) define a variable vertical position for the one or more heating elements (202-206) relative to the diffusion plate 110 for securing the one or more heating elements (202-206) against the diffusion plate 110. Further, the securing of the one or more heating elements (202-206) against the diffusion plate 110 reduces a thermal contact resistance between the one or more heating elements (202-206) and the diffusion plate 110.

In some embodiments, the two or more horizontal members (302-308) and the two or more vertical members (310 and 312) may include two or more C-aluminum channels.

In some embodiments, the two or more horizontal members (302-308) and the two or more vertical members (310 and 312) may include two or more T-slotted aluminum extrusions.

In some embodiments, the perimeter of the diffusion plate 110 extends laterally beyond an outer perimeter of the heater 108 to perform one or more of capturing the heat emitted at an edge region of the heater 108 and redistributing a captured heat across the diffusion plate 110.

In some embodiments, the diffusion plate 110 may be mechanically integrated with the frame 102 by separating the flat lower surface 504 of the diffusion plate 110 from the upper heat-emitting surface 502 by an air gap. Further, the air gap defines a thermal interface moderating a direct heat transfer between the upper heat-emitting surface 402 and the flat lower surface 504 of the diffusion plate 110. Further, a load of the diffusion plate 110 and the load of the container 112 containing the liquid may be supported by each of the two or more mechanical fasteners (118-124) and the two or more adjustable support members (314-330) supporting the one or more heating elements (202-206). Further, each of the two or more mechanical fasteners (118-124) and the two or more adjustable support members (314-330) may be in direct contact with the two or more horizontal members (302-308) of the frame 102.

In some embodiments, the diffusion plate 110 may exhibit a non-linear temperature rise across at least one of the flat lower surface 504 and the flat upper surface 502 as a result of the air gap.

In some embodiments, the exhibiting of the non-linear temperature rise comprises exhibiting the non-linear temperature rise during the process of heating one or more of the water and the sugary wort at the higher-than-normal power level.

In some embodiments, the lower mounting surface 404 of the one or more heating elements (202-206) may be configured to support the one or more heating elements (202-206) against the flat lower surface 504 of the diffusion plate 110 to minimize a thermal conduction resistance due to the air gap.

In some embodiments, the lower mounting surface 404 of the one or more heating elements (202-206) comprises a mounting frame. Further, the mounting frame comprises a Y-frame. Further, the pressing of the one or more heating elements (202-206) against the flat lower surface 504 of the diffusion plate 110 comprises pressing the one or more heating elements (202-206) against the flat lower surface 504 of the diffusion plate 110 using the Y-frame.

In some embodiments, the two or more adjustable support members (314-330) may be configured for supporting a load of the container 112 during the brewing process. Further, the two or more mechanical fasteners (118-124) may support a fraction of the load during the brewing process.

In some embodiments, the load may correspond to an excessive weight corresponding to an excessive water weight during the brewing process.

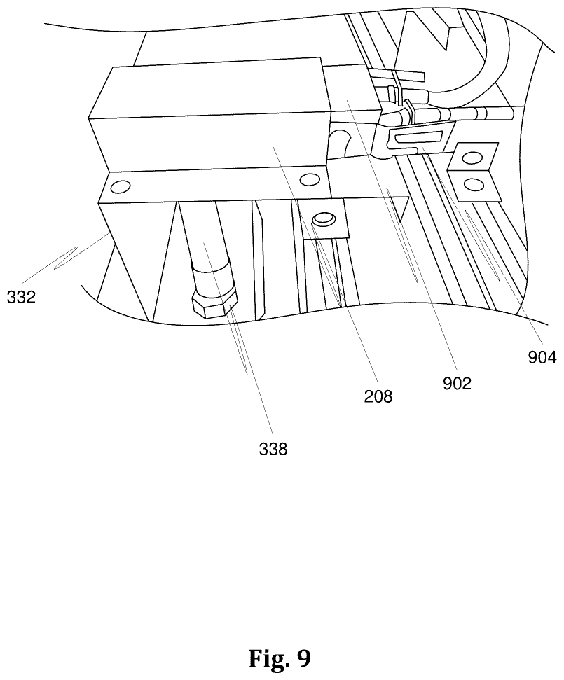

FIG. 9 illustrates an electric box 208 mounted on a bracket assembly 332 of the heating apparatus 100 for facilitating uniform high-power heating of liquid, in accordance with some embodiments. Further, the frame 102 may include the bracket assembly (332-336), as shown in FIG. 3, which may be configured to receive the one or more electric boxes (208-212), as shown in FIG. 2.

Further, in some embodiments, an assembly of the heating apparatus 100 may be performed by initially positioning the one or more burners in a predetermined location. Further, the receptacle block 902, comprising two uninsulated ¼-inch female terminals, is configured to align with and electrically engage the one or more burners. Further, engagement of the receptacle block 902 with the one or more burners establishes and defines the installation height of the bracket assembly (332-336). Further, a metal receptacle bracket 904 is provided to mechanically secure the receptacle block 902 to the one or more burners. Further, a mounting screw is further implemented to mechanically couple the receptacle bracket 904 to bracket B. Further, each of the one or more electrical boxes (208-212) is mounted to the receptacle bracket 904 using four fasteners, with a PEM element inserted into an underside portion of bracket B. The one or more electrical boxes (208-212) mechanically secure the receptacle block 902 to bracket B and enclose associated wire connections in compliance with applicable NEC standards. Further, the assembled configuration is arranged so as not to substantially obstruct heat flow between the heater and the diffusion plate. Further, the assembly thereby provides both electrical interconnection and mechanical support between the controller 114 and the one or more burners.

In some embodiments, the diffusion plate 110 and the frame 102 may cooperate to form a composite structure. Further, the diffusion plate 110 may function as both a thermal element and a structural member supporting the container in the composite structure.

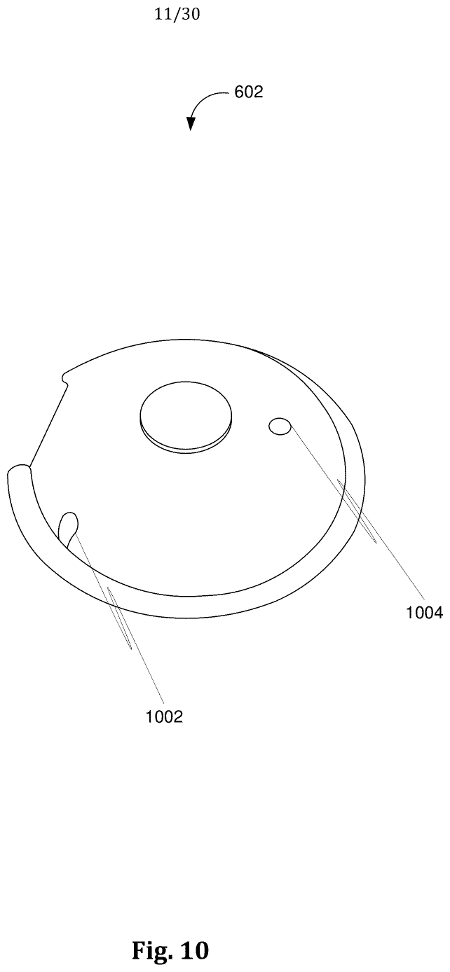

FIG. 10 illustrates a thermal shield 602 of the heating apparatus 100 for facilitating uniform high-power heating of liquid, in accordance with some embodiments. Further, FIG. 10 shows a bottom view of the thermal shield 602. Further, the one or more thermal shields (602-606) may be attached to the two or more slotted headed screws and positioned beneath the one or more heating elements (202-206). Further, the one or more thermal shields (602-606) comprises two or more holes (1002 and 1004) configured to receive the two or more slotted headed screws. Further, the one or more thermal shields (602-606) may be configured to allow a contact between the mounting frame and the two or more slotted headed screws after attaching the one or more thermal shields (602-606) to the two or more slotted headed screws. Further, the one or more thermal shields (602-606) may be further configured to shield one or more wiring components from the heat.

In some embodiments, the one or more thermal shields (602-606) may be configured to protect one or more conductive wires from the heat to reduce a temperature of the one or more conductive wires. Further, the one or more heating elements (202-206) may be electrically coupled with the controller 114 using the one or more conductive wires.

Further, the heating apparatus 100 further comprises a pump fluidly coupled with the container 112. Further, the pump may be configured for moving a hot liquid between the container 112 and one or more additional containers based on a power received by the pump. Further, the controller 114 comprises a Ground Fault Circuit Interrupter (GFCI) breaker configured for interrupting the power supplied to the pump. Further, the interrupting of the power protects the controller 114 against an electrical leakage.

In some embodiments, the heating apparatus 100 may include an electrical conduit 338 extending between the controller 114 and the one or more heating elements (202-206). Further, the electrical conduit 338 may be attached to an inner surface of the two or more horizontal members (302-308). Further, the electrical conduit 338 may be configured to provide a passageway for a conductive wire from the controller 114 to a receptacle block 902. Further, the controller 114 may be electrically coupled with the heater 108 using the conductive wire. Further, the heating apparatus 100 includes a bracket assembly (332-336) mounted on the two or more horizontal members (302-308). Further, the electrical conduit 338 may be routed to the bracket assembly 332. Further, the bracket assembly (332-336) comprises a circular opening configured to receive a protected threaded connector of the electrical conduit 338. Further, the bracket assembly 332 may be further configured to receive the one or more electric boxes (208-212). Further, the heating apparatus 100 may include the one or more electric boxes (208-212) mounted on the bracket assembly (332-336). Further, the electric box 208 may be configured to secure the receptacle block 902 in the bracket assembly (332-336). Further, the heating apparatus 100 may include the receptacle block 902 comprising two uninsulated female terminals (1602 and 1604). Further, the conductive wire extending from the controller may be connected to the receptacle block 902 using the two uninsulated female terminals (1602 and 1604). Further, the receptacle block 902 may be configured to receive two male electrodes of the one or more heating elements (202-206) to establish a connection between the two uninsulated female terminals (1602 and 1604) and the two male electrodes of the one or more heating elements (202-206). Further, the generating of the heat may be based on the establishing of the connection between the two uninsulated female terminals (1602 and 1604) and the two male electrodes.

FIG. 11 illustrates a rear view of the heating apparatus 100 for facilitating uniform high-power heating of liquid, in accordance with some embodiments. Further, the rear view of the heating apparatus 100 shows the controller 114, the frame 102, and the diffusion plate 110.

Further, the heating apparatus may include a safety receptacle 1102. Further, in some embodiments, the safety receptacle may be and/or may include a 120 VAC Ground Fault Circuit Interrupter (GFCI) protected outlet. Further, the safety receptacle 1102 may be configured to be coupled with the pump. Further, the pump is configured to be plugged into the safety receptacle 1102 to be protected when operating in wet areas. Further, the pump may be configured to safely move a hot liquid at one or more high temperatures during the brewing process.

In some embodiments, the container 112 may comprise two or more containers comprising a first container and a second container. Further, the controller 114 may include a pump system. Further, the pump system may be fluidly coupled with each of the two or more containers. Further, the pump system may be configured for moving the liquid from the first container to the second container.

In some embodiments, the first container comprises the liquid comprising hot liquid. Further, the pump system may include a food-grade magnet drive water pump fluidly coupled with each of the two or more containers. Further, the moving of the liquid from the first container to the second container comprises moving the liquid from the first container to the second container using the food-grade magnet drive water pump.

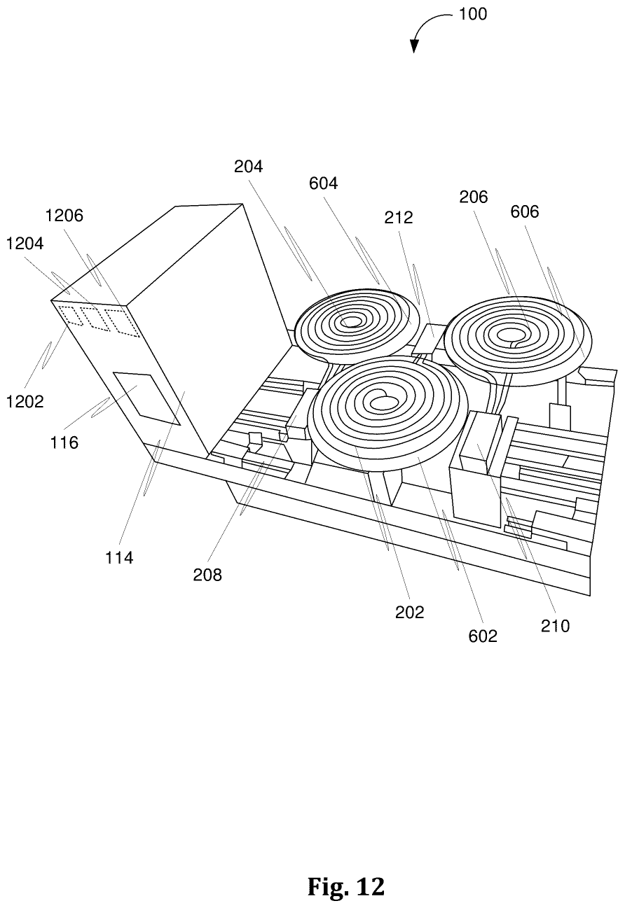

FIG. 12 illustrates a perspective view of the heating apparatus 100 for facilitating uniform high-power heating of liquid, in accordance with some embodiments. In some embodiments, the controller 114 comprises one or more circuit breakers (1202-1206). Further, the one or more circuit breakers (1202-1206) may be electrically coupled with the one or more heating elements (202-206). Further, the one or more circuit breakers (1202-1206) may be configured for protecting the two or more one or more heating elements (202-206), including wires and connectors. Further, the one or more circuit breakers (1202-1206) may be further configured for preventing main breaker panel from tripping in case of a tripped branch circuit breaker.

In some embodiments, the one or more circuit breakers (1202-1206) comprise a first breaker 1202, a second breaker 1204, and a third breaker 1206. Further, the one or more heating elements (202-206) comprise the first heating element 202, a second heating element 204, and a third heating element 206. Further, the first breaker 1202 is electrically coupled with the first heating element 202 and configured to protect the wiring of the first heating element 202 from the electrical damage. Further, the second breaker 1204 is electrically coupled with the second heating element 204 and configured to protect the wiring of the second heating element 206 from the electrical damage. Further, the third breaker 1206 is electrically coupled with the third heating element 206 and configured to protect the wiring of the third heating element 206 from the electrical damage.

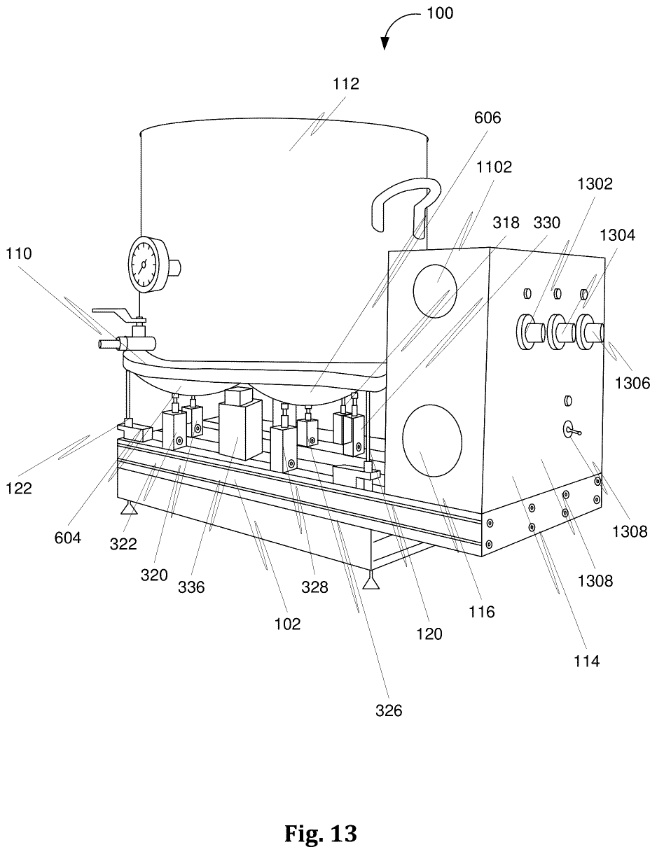

FIG. 13 illustrates a second perspective view of the heating apparatus 100 for facilitating uniform high-power heating of liquid, in accordance with some embodiments. In some embodiments, the controller 114 comprises one or more regulators (1302-1306). Further, the regulating of the electrical power supplied to the heater 108 comprises regulating the electrical power supplied to the one or more heating elements (202-206) based on one or more actions applied to the one or more regulators (1302-1306) by one or more users.

Further, in some embodiments, the one or more regulators (1302-1306) may include one or more double-pole single-throw (DPST) switches. Further, the application of one or more actions on the one or more regulators (1302-1306) may include the application of the one or more actions on the DPST switches.

Further, the one or more actions on the one or more regulators (1302-1306) may include one or more of a rotation and an actuation of the one or more regulators (1302-1306).

Further, in some embodiments, the controller 114 comprises a pump switch 1308. Further, the pump switch 1308 may be configured for regulating an activation and a deactivation of power to the safety receptacle 1102.

In some embodiments, the one or more regulators (1302-1306) comprise one or more infinite switches.

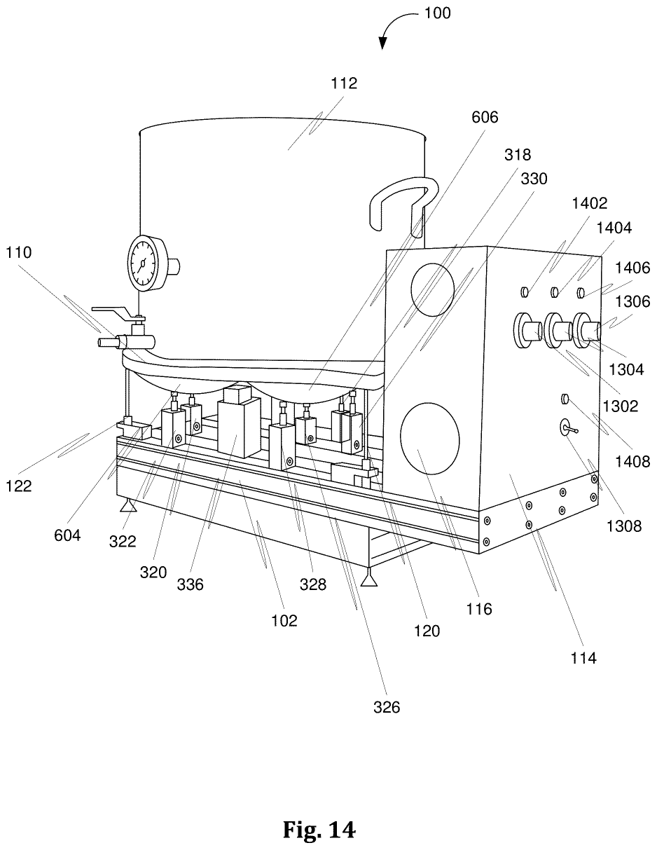

FIG. 14 illustrates a perspective view of the heating apparatus 100 for facilitating uniform high-power heating of liquid, in accordance with some embodiments. In some embodiments, the controller 114 may include one or more indicators (1402-1406). Further, the one or more indicators (1402-1406) may be configured to generate a first light based on the regulating of the electrical power supplied to the heater 108. Further, the first light indicates a status of the regulating of the electrical power.

In some embodiments, the status of the regulating of the electrical power comprises one of an on status of the regulating of the electrical power and an off status of the regulating of the electrical power.

In some embodiments, the one or more indicators (1402-1406) may include a pump-status indicator 1408 electrically coupled with a pump system. Further, the pump-status indicator 1408 may be further configured to generate a second light based on an operational state of the pump system. Further, the operational state comprises one of an on state of the pump system and an off state of the pump system.

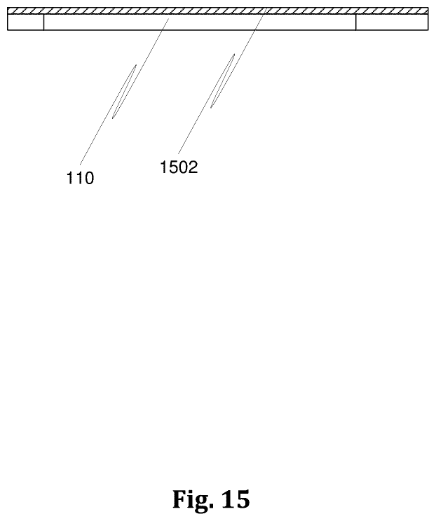

FIG. 15 illustrates a side view of the diffusion plate 110, in accordance with some embodiments. Further, the diffusion plate 110 may include one or more coatings 1502 comprising a fluoropolymer material. Further, the fluoropolymer material may be configured to withstand a temperature of the diffusion plate 110. Further, the one or more coatings 1502 may be configured to reduce an adhesion of one or more residues to the flat upper surface 502.

In some embodiments, the diffusion plate 110 may be provided without the one or more coatings 1502. Further, the diffusion plate 110 may have a polished surface facilitating heat transfer, thereby allowing the diffusion plate 110 to maintain a desired temperature during operation. Further, the polished surface may reduce the adhesion of the one or more residues to the diffusion plate 110.

In some embodiments, the fluoropolymer material comprises polytetrafluoroethylene. Further, the one or more residues comprise wort residues.

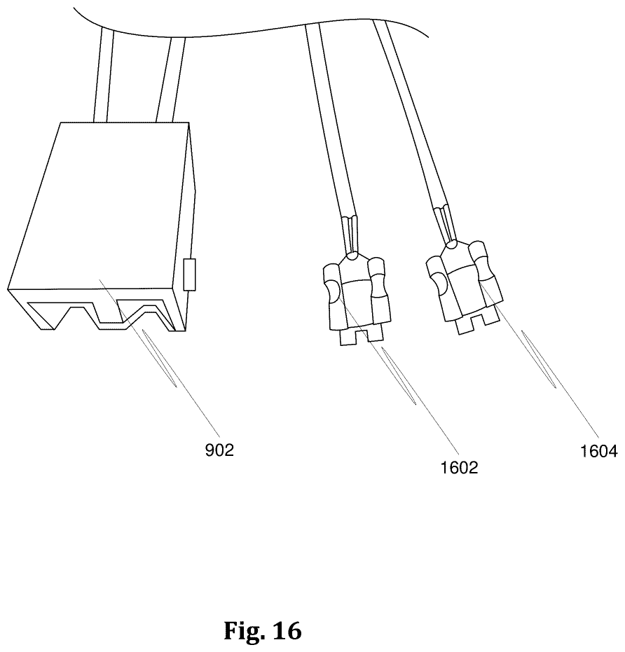

FIG. 16 illustrates a perspective view of the receptacle block 902 of the apparatus 100, in accordance with some embodiments. Further, FIG. 16 shows two insulated female terminals (1602 and 1604) of the receptacle block 902. Further, the one or more heating elements (202-206) may be electrically coupled with the controller 114 through the receptacle block 902. Further, the electric box 208 comprises the receptacle block 902 comprising the two insulated female terminals (1602 and 1604).

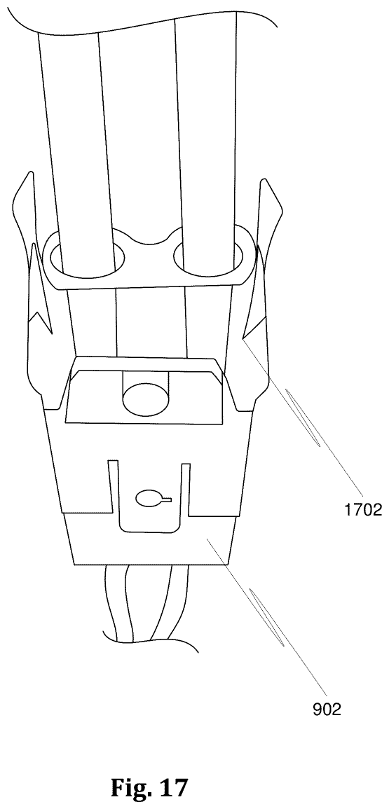

FIG. 17 illustrates a bottom view of the metal receptacle bracket 1702, in accordance with some embodiments. Further, the metal receptacle bracket 1702 may be configured to secure the receptacle block 902 with the one or more heating elements (202-206).

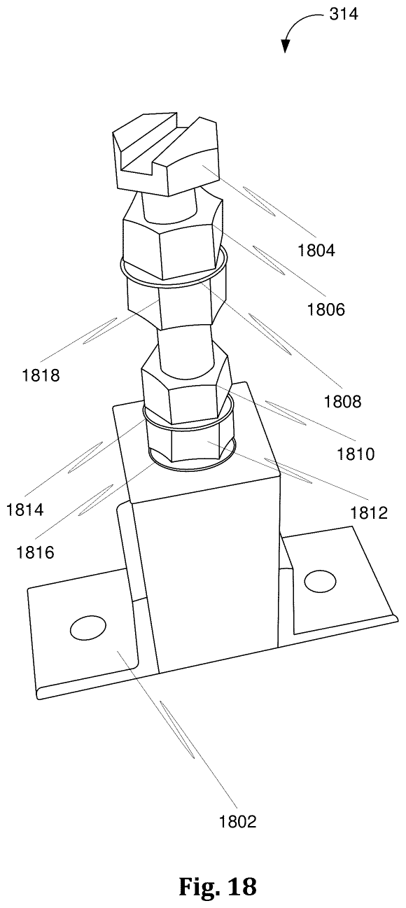

FIG. 18 illustrates a perspective view of a first adjustable support membrane 314, in accordance with some embodiments. Further, the first adjustable support membrane 314 comprises a burner support base 1802, an adjustable slotted aluminum bolt 1804, aluminum nuts (1806, 1818, 1810, and 1812), and aluminum washers (1808, 1814, and 1816).

In some embodiments, the heater 108 may include a high-frequency capacitor discharge circuit.

In some embodiments, the controller 114 comprises a Proportional-Integral-Derivative (PID) controller to manage the solid-state relay. Further, the PID controller may be configured to adjust the electrical power based on a difference between a desired variable and a measured variable.

In some embodiments, the desired variable may be a desired temperature of the diffusion plate, and the measured variable may be an actual temperature of the diffusion plate.

In some embodiments, the controller 114 comprises a dual solid-state relay. Further, the regulating of the electrical power comprises regulating the electrical power supplied to the heater 108 using the dual solid-state relay.

Further, in some embodiments, the regulating of the electrical power comprises regulating the electrical power supplied to the heater using a double-pole double-throw (DPDT) relay. Further, the DPDT relay is configured to alternately switch the heater 108 between separate power paths, thereby distributing the current load across multiple contacts. Further, the switching of the heater 108 between the separate power paths reduces a power loss in each individual contact of the DPDT relay, improving overall switching efficiency and minimizing heat generation in the switching device.

In some embodiments, the controller 114 comprises a high-power fuse configured to protect the solid-state relay during an overload condition.

In some embodiments, the heating apparatus 100 comprises a proximity sensor. Further, the proximity sensor may be configured for detecting presence of the container 112 positioned above the diffusion plate 110. Further, the container 112 may include a pot configured for placement on the diffusion plate 110. Further, the regulating of the electrical power supplied to heater 108 may be further based on the detecting presence of the container 112 positioned above the diffusion plate 110.

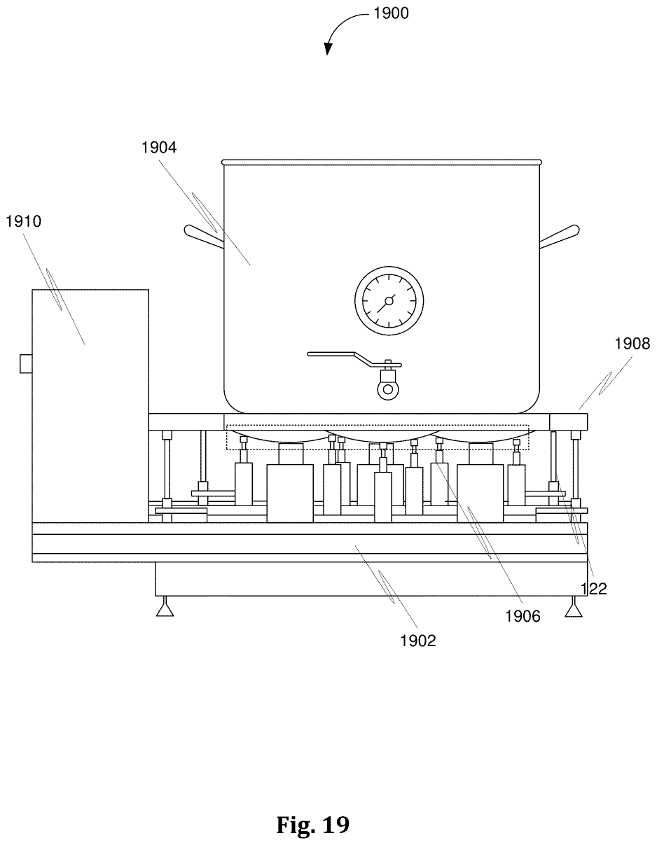

FIG. 19 illustrates a heating apparatus 1900 for facilitating uniform high-power heating of liquid, in accordance with some embodiments. Further, the heating apparatus 1900 may include a frame 1902 which may be configured for supporting a container 1904. Further, the heating apparatus 1900 may include a heater 1906 attached to the frame 1902. Further, the heater 1906 may be configured for generating heat. Further, the heating apparatus 1900 may include a diffusion plate 1908 mechanically integrated with the frame 1902. Further, the diffusion plate 1908 may be positioned between the heater 1906 and the container 1904 containing the liquid. Further, the liquid may include sugar. Further, the distributing of the heat uniformly to the container 1904 reduces one or more of caramelization of the sugar in the liquid and burning of the sugar in the liquid on the bottom surface of the container 1904. Further, the diffusion plate 1908 may be configured for receiving the heat from the heater 1906. Further, the diffusion plate 1908 may be configured for distributing the heat uniformly to the container 1904. Further, the heating apparatus 1900 may include a controller 1910 electrically coupled to the heater 1906. Further, the controller 1910 may be configured for regulating a power supplied to the heater 1906 to control the generating of the heat.

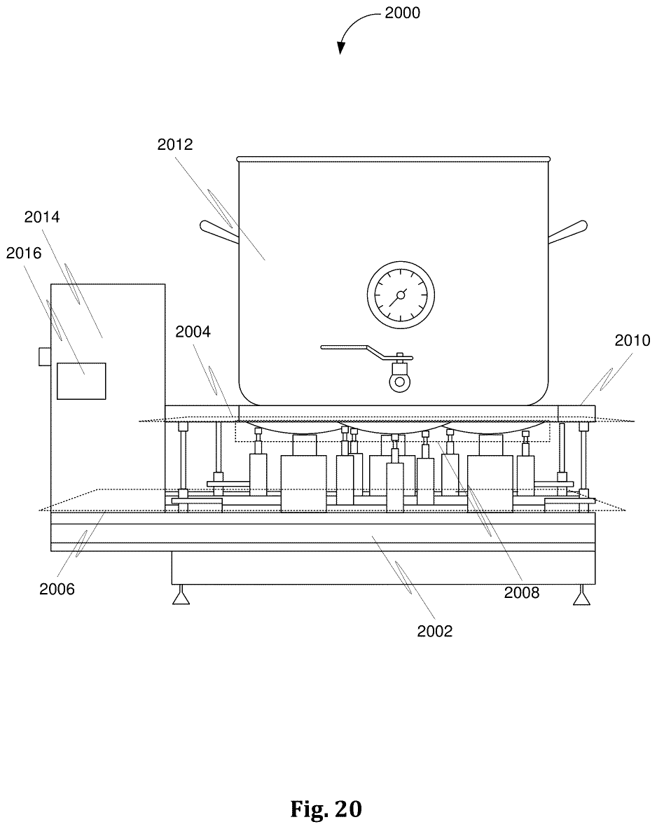

FIG. 20 illustrates a heating apparatus 2000 for facilitating uniform high-power heating of liquid in a container while reducing localized overheating, in accordance with some embodiments. Further, the heating apparatus 2000 may include a frame 2002 comprising a rigid elongated body formed from two or more horizontal members and two or more vertical members joined to define an open structure having an upper plane 2004 and a lower plane 2006. Further, the frame 2002 may be configured for supporting a load above the upper plane 2004. Further, the heating apparatus 2000 may include a heater 2008 comprising a heating element formed as a continuous metal coil having an upper heat-emitting surface and a lower mounting surface. Further, the heater 2008 may be mechanically attached to the frame 2002 by facing the upper heat-emitting surface upward. Further, the heater 2008 may be configured for generating heat. Further, the heating apparatus 2000 may include a diffusion plate 2010 comprising a solid planar metal body having a flat upper surface and a flat lower surface. Further, the diffusion plate 2010 may be positioned above the heater 2008. Further, the diffusion plate 2010 may be mechanically integrated with the frame 2002. Further, the flat lower surface of the diffusion plate 2010 faces the upper heat-emitting surface of the heater 2008 to receive heat from the upper heat-emitting surface. Further, the flat upper surface of the diffusion plate 2010 may be configured for direct contact with a bottom surface of a container 2012 containing the liquid. Further, the flat upper surface may be configured for transferring the heat to the bottom surface of the container 2012 uniformly to reduce one or more of caramelization of sugar in the liquid and burning of the sugar in the liquid on the bottom surface of the container 2012. Further, the solid planar metal body of the diffusion plate 2010 includes a monolithic metal plate body having a continuous internal volume and two or more opposing major faces. Further, the monolithic metal plate body may be formed from a material exhibiting high thermal conductivity. Further, the heat may be received from the upper heat-emitting surface at a localized region on the flat lower surface, which spreads laterally across the continuous internal volume before the heat reaches the flat upper surface. Further, the transferring of the heat to the bottom surface may be based on the heat reaching the flat upper surface. Further, the heating apparatus 2000 may include a controller 2014 electrically connected to the heater 2008. Further, the controller 2014 may be configured for regulating an electrical power supplied to the heater 2008 to control the generating of the heat. Further, the heating apparatus 2000 may include a power terminal 2016 configured to receive the electrical power. Further, the power terminal 2016 may be electrically connected to each of the heater 2008 and the controller 2014.

In some embodiments, the input power factor of the heating apparatus 100 is approximately equal to 1 using resistive heaters.

Further, in some embodiments, the resistive heaters may be replaced with induction heaters employing a ferrous plate as the heating element.

Further, in some embodiments, a chassis ground wire is directly connected to the frame 102 from the controller 114.

Further, in some embodiments, the two or more T-slotted aluminum extrusions are made with clear anodized aluminum and black anodized profiles that provide corrosion resistance to the frame 102. (Anodizing puts a thin coat of aluminum oxide (Al₂O₃) on the surface of the extrusion, 5-25 μm typical, 50-100 μm for hard-anodizing. This is a standard 8020 Inc. product.)

FIG. 21A-FIG. 21B illustrate Diffusion Plate and Water Temperature vs. Time graphs, in accordance with some embodiments. Further, in some embodiments, the Diffusion Plate and Water Temperature vs. Time graphs may include a First Diffusion Plate and Water Temperature vs. Time graph 2102 utilizing seconds for the time axis, as shown in FIG. 21A. Further, in some embodiments, the Diffusion Plate and Water Temperature vs. Time graphs may include a Second Diffusion Plate and Water Temperature vs. Time graph 2104 utilizing minutes for the time axis, as shown in FIG. 21B.

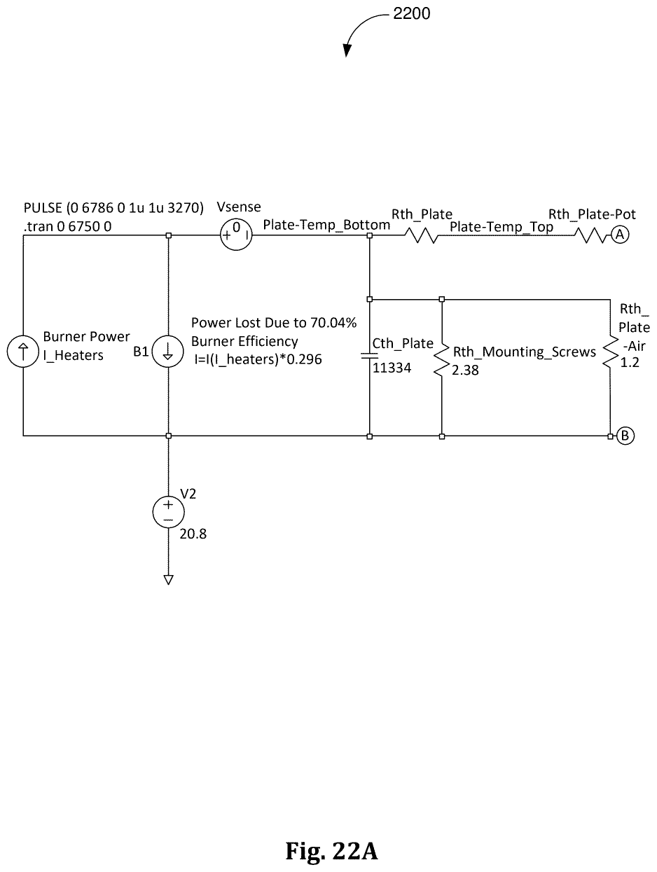

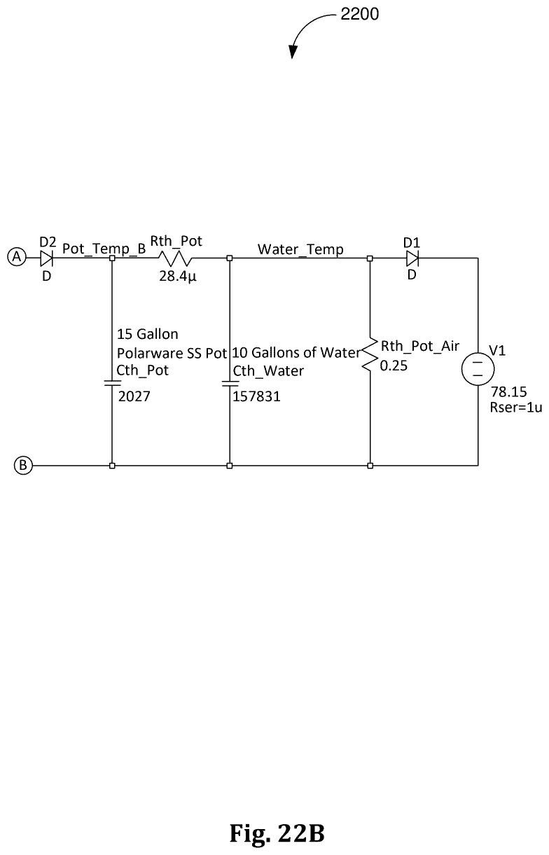

FIG. 22A-FIG. 22B illustrate a thermal circuit 2200 for the heating apparatus 100, in accordance with some embodiments.

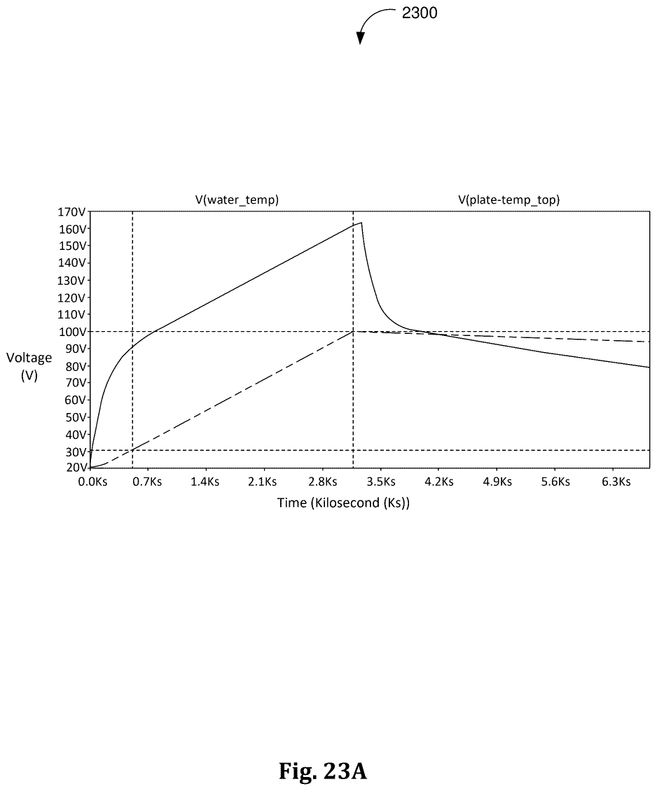

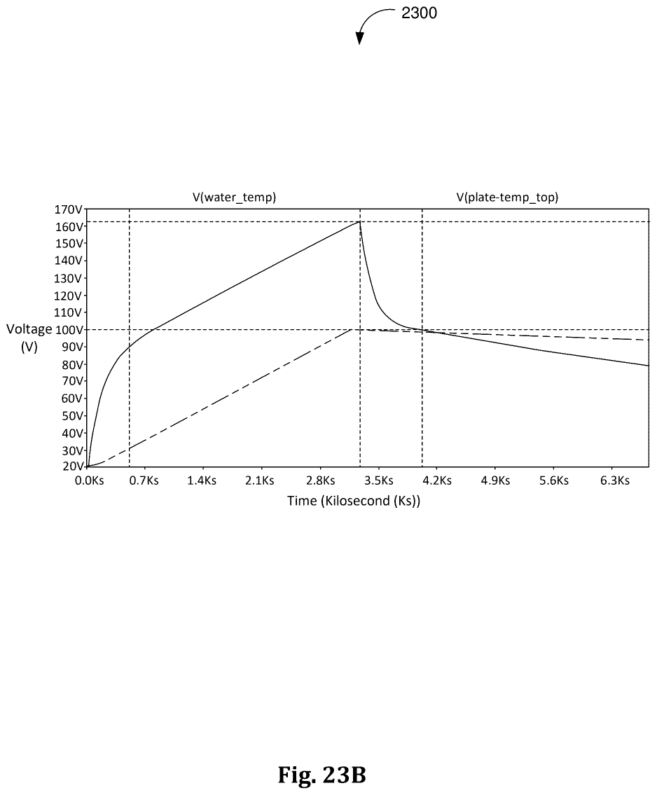

FIG. 23A-FIG. 23B illustrate a validation graph 2300, in accordance with some embodiments. Further, in some embodiments, the validation graph 2300 may be used to measure a temperature slope, to validate power being transferred to the liquid and the container 112. Further, in some embodiments, the validation graph 2300 may be used to determine a peak temperature of the diffusion plate 110 and a thermal time constant, which is associated with a thermal capacitance of the diffusion plate 110 as it releases energy through a thermal resistance interface between the diffusion plate 110 and the container's bottom.

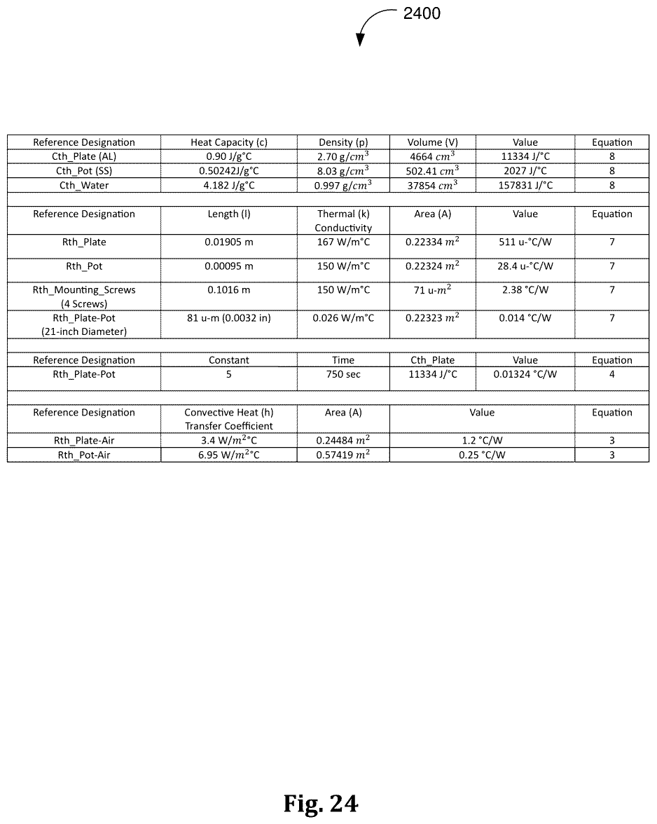

FIG. 24 illustrates a table 2400 representing one or more circuit components comprised in the thermal circuit 2200, in accordance with some embodiments. Further, the table 2400 may depict one or more of heat capacity, density, volume, and value associated with the one or more components relative to the thermal circuit 2200.

In some embodiments, the present disclosure describes a frame structure consisting of extruded metal, characterized by elongated sections that maintain consistent profiles, which may range from straightforward to intricate designs. Further, the frame structure provides the foundation that supports all the major components. Further, the frame supports the heating elements, the diffusion plate, and the controller.

Further, in some embodiments, the heating elements may be and/or may include the one or more heating elements (202-206).

Further, in some embodiments, the diffusion plate may be and/or may include the diffusion plate 110.

Further, in some embodiments, the frame structure may be and/or may include the frame 102.

Further, in some embodiments, the controller may be and/or may include the controller 114.

Further, the BHP prototype features a frame constructed from four horizontal and two vertical aluminums C-channels. Further, the horizontal sections measure 0.125 inches in thickness, 1 inch in width, 2 inches in height, and 27 inches in length. Further, the vertical sections have dimensions of 0.125 inches in thickness, 1 inch in width, 2 inches in height, and 12.25 inches in length.

Further, the BHP2 is constructed using four horizontal and two vertical T-slot aluminum extrusions for its frame. The horizontal components measure 1 inch in thickness, 2 inches in height, and 29 inches in length. Further, the vertical components have dimensions of 1 inch in thickness, 2 inches in height, and 12.25 inches in length. Further, the T-slot aluminum extrusions serve as the framework, facilitating a more efficient and straightforward assembly process. Further, the T-slot aluminum extrusions also offer designated spaces for attaching panels and various hardware components, such as faceplates, mounting fixtures, brackets, electrical conduits, and pumps. Further, the updated control panel is now equipped with connectors to facilitate the application of input power for the burners and the switched output power for a pump.

Further, the heating element features a spiral-shaped tubular coil measuring 8 inches in diameter. Further, the heating element is composed of a metal sheath that encloses an insulated resistance wire.

Further, the heater generates heat by passing an electric current through the heater's resistance wire. Further, the heat is transferred to the metal sheath of the heater. When the diffusion plate comes into direct contact with the heated surface of the metal sheath, the heat flows from the heater to the diffusion plate.

Further, in some embodiments, the heater may be and/or may include the heater 108.

Further, the BHP prototype incorporates three two-element 2.2 KW Calrod heaters and a diffusion plate. Further, the input power cable is directly integrated into the control enclosure. High-temperature oven wire was utilized, with the wiring secured using tie wraps, and no wire conduit was employed.

Further, the control panel for the BHP prototype offers sixty-four power levels for the heaters, managed by six Single Pole Single Throw (SPST) 240 VAC switches. The six Single Pole Single Throw (SPST) 240 VAC switches provide power to three two-element Calrod burners, each equipped with both high (46 ohm) and low (59 ohm) power elements. The sixty-four power settings are adequate for effectively regulating the boiling rate of wort during the home brewing process. Additionally, incandescent lamps are wired across each heating element to indicate that power is being supplied to the heating components. The latest iteration, the second-generation brewing hotplate (BHP2), is equipped with standardized plug receptacles that allow for the connection of three interchangeable, field-repairable 2.2 KW Calrod heating burners (model WB30M2), delivering a combined output of 6.6 KW for operational efficiency.

Further, the BHP2 was subjected to electrical and thermal assessments to determine the BHP2's performance following various electrical and mechanical modifications. Further, a stainless steel Polarware pot was used to heat 10 gallons of water, with temperatures ranging from 20° C. to 100° C. A 4-Channel Thermocouple Thermometer Data Logger (TC 0521) equipped with K-type thermocouples was utilized to monitor the temperature of the plate's upper surface and the water being heated. The temperature data were represented graphically in FIG. 21A and FIG. 21B by a “Diffusion Plate and Water Temperature vs. Time” graph. Further, the “Diffusion Plate and Water Temperature vs. Time” graph, illustrated in FIG. 21A utilize seconds for the time axis. Further, the “Diffusion Plate and Water Temperature vs. Time” graph, illustrated in FIG. 21B utilize minutes for the time axis. Further, the validation graph 2300, illustrated in FIGS. 23A-23B utilize kiloseconds (Ks) for the time axis.

A simulation model was created to analyze the rate at which water quantities utilizing the BHP2 may be heated. The above approach enables the construction of models of the BHP2 based on the BHP2's geometric characteristics. By leveraging the shared mathematical principles of electrical and thermal circuits, a program designed for electric circuit transient analysis can effectively assess the transient behavior of thermal circuits. The electrical circuit shown in FIG. 22A and FIG. 22B represents a simplified thermal circuit for the BHP2.

In accordance with FIG. 23A, the temperature slope is measured to validate the power being transferred to the water and the pot. FIG. 23B focuses on determining the peak temperature of the plate and the thermal time constant, which is associated with the thermal capacitance of the plate as it releases energy through the thermal resistance interface between the plate and the pot's bottom. FIG. 24 presents the components involved in the thermal transient analysis for the simulation circuit illustrated in FIG. 22A and FIG. 22B.

In FIG. 22A and FIG. 22B, the electrical circuit is described sequentially from left to right. The comparison between analog and thermal circuits can be established by adapting Ohm's law from electronics to its thermal counterpart, utilizing (2) and (12). The BHP2 receives its input power from three high-power Calrod burners. The calculation of power using (11) relies on the measured line voltage and the resistance of the burner coil. Some of the power from the burner is lost to the environment and is modeled as a percentage of the total burner power using (5). A voltage source, set to zero, is used to view the adjusted power to the circuit, as shown in FIG. 22A. Three thermal resistances (Rth_Plate, Rth_Pot, Rth_Mounting_Screws) are established through the application of the conduction equation (7), and two additional thermal resistances (Rth_Plate-Air, Rth_Pot-Air) are calculated using the natural convective heat transfer coefficient equation (3). The thermal resistance (Rth_Plate-Pot) was obtained by using (7) and verified by (4) (See FIG. 24). The calculation of three thermal capacitances (Cth_Plate, Cth_Pot, Cth_Water) is performed using (8). A diode (D1) is used to hold the temperature of water at 100° C. D2 is used to match the plate and water temperature over time when the power is turned off. V1 and V2 set the water temperature to a maximum of 100° C. V2 is also the reference for ambient temperature.

If the temperature shows an increase over time, along with the thermal capacitance of both the water and the pot, we may apply (1) to calculate the power being transferred to the water and the pot. Using the linear segment of the waveform illustrated in FIG. 21A, we may determine the ΔT/Δt. The slope is calculated as (100−27.4)/(2940−510)=0.0299. Multiplying this slope by a thermal capacitance of 159,858 J/° C. gives us a total power of 4780 W. The input power of the circuit was calculated to be 6786 W RMS, using (11), which was derived from a measured voltage of 233 V RMS and a burner coil resistance of 24 ohms. Equation (5) allows us to compute the efficiency of the Calrod heating coils. The efficiency is derived from the ratio of 4780 W to 6786 W, which gives us a value of 70.4%.

According to the data presented in FIG. 21B, the time taken to heat 10 gallons of water with a burner rated at 6786 W was measured at 49.25 minutes. The given figure accounts for a warm-up phase of 2.25 minutes, necessary for the diffusion plate to reach a temperature higher than that of the water. Therefore, the actual time required to heat the water is 47 minutes, also defined in equation (9).

Further, by improving the efficiency of the heating circuit referenced in (6), the power delivered to the water and pot (Pout) will increase, leading to a shorter heating time. Calrod heaters are almost purely resistive and have a unity power factor (PF), so electrical power is effectively being converted into useful work output without using switch-mode power supplies that generate electromagnetic interference (EMI). Inductive heating can be investigated to heat steel diffusion plates to increase efficiency, but at the tradeoff of reliability, cost, and EMI.

Further, a desirable aspect is to have the lowest thermal resistance interface between the top of the plate and the bottom of the pot, lowering the plate temperature and the temperature of the control enclosure. The given aspect also serves as a measure of the quality and flatness of the plate and pot, as well as an assessment of whether we have optimized the thermal resistance at this interface. A comparison of the test waveforms with the simulated waveforms reveals a non-linear temperature effect on the plate temperature, while the slope of the temperature across the thermal capacitances of both the pot and the water, remains linear. The effective thermal conductivity of the air gap (K) is higher and more nonlinear when heating the water to 100 C causing the plate temperature to rise in a non-linear manner. Rth_Plate-Pot is defined in equation (7).

Once the water temperature reaches 100° C., there is effectively no change in the temperatures of the water or the plate. The maintained temperature difference of 67° C. between the plate and water provides an opportunity for a reliable thermal resistance measurement using (2). The thermal resistance (Rth_Plate-Pot) is determined by dividing the temperature difference of 67° C. by the power used to heat the water and pot, which is 4780 W, yielding a result of 0.014° C./W.

Further, by disconnecting the input power once the water has stabilized at 100° C., we can determine the duration required for the energy stored in the plate to be transferred to the water at that temperature. Subsequently, we can rearrange (4) to calculate the resistance between the plate and the pot (Rth_Plate-Pot). The thermal resistance is calculated by taking the thermal time constant (Tau=765 s) and dividing it by five times the thermal capacitance of the plate (Cth_Plate-Pot=11334 J/° C.), resulting in a value of 0.0135° C./W. The thermal resistance (Rth_Plate-Pot) was calculated by two separate methods with a percentage difference of 3.6%. This minimal difference indicates that the thermal resistance values from both steady-state and transient calculation techniques are comparable. A thermal resistance of 0.014° C./W is equivalent to maintaining a uniform air thickness (gap) of 0.0032 inches beneath a brew pot that has a diameter of 21 inches.

To a home brewer, an effective heater control is crucial once the wort has been collected and heated to 100° C., as it allows for a steady “rolling” boil without the risk of boil overs. The BHP2 offers precise heating control through infinite switches, ensuring a consistent rolling boil, even when the brew pot is nearly full.

The diffusion plate is designed with a substantial area and is made from thick, sturdy material. It is attached to the frame at four corners, featuring mounting holes that provide additional support to the frame's structure. Constructed from aluminum, this plate offers superior thermal conductivity, allowing for rapid heat absorption and distribution. In heating applications, it effectively ensures that heat is evenly spread across its surface, avoiding hot spots and promoting consistent heating when a pot is placed on top.

A durable, thick aluminum diffusion plate is installed between the source of high heat and the base of the brew pot, allowing for the even distribution of heat across the thin, thermally conductive bottom of the brew pot. This arrangement effectively reduces “hot spot” temperatures, therefore preventing the wort from caramelizing, scorching, or burning when applying high-power to reduce brewing time. The diffusion plate is integrated mechanically into a sturdy aluminum frame to safely support the weight of larger than normal batches of home-brewed beer and the brewing equipment, such as the brew pot and lid.

One objective of the disclosed apparatus is to seamlessly incorporate a diffusion plate into the brew plate's frame structure, which will contribute to mechanical robustness and reduce the weight load experienced by the electrical burners. An additional feature of the disclosed apparatus is the use of a diffusion plate's high thermal conductivity and capacity to absorb, store, and distribute heat more effectively, which contributes to the reduction of thermal hot spots across its surface interfaces. Another purpose of the disclosed apparatus is to leverage efficient thermal conduction for heat transfer between the diffusion plate, heating elements, and brew pot, in conjunction with radiated heat transfer.

Positioned on top of the burners, the diffusion plate is securely held in place at four corner points to the frame by an adjustable two-piece fastener base, which includes both a top and a bottom section. Each corner of the plate features a 5.5-inch-long ⅜-16 threaded rod that is screwed into the diffusion plate 110 using threaded holes and secured with a washer, lock washer, and nut. The other end of the threaded rod is connected to the top tab section of the fastener using additional nuts and washers. The bottom part of the fastener is then aligned against the underside of the top part, utilizing the thick slot and groove mechanism. The underside of the fastener assembly includes a narrower extrusion that fits into a designated slot on the upper section of the extruded aluminum frame. Two Button Head Socket Cap Screws (BHSCS) are inserted through the holes of the assembled fasteners and fastened into two T-nuts, just enough to keep the assembly intact. The two-piece fastener assembly is then slid onto the top side of the 1-inch by 2-inch extruded aluminum frame.

The BHSCS are tightened to a torque level that activates the “drop lock function,” creating a 2° decline of the T-slot flange to prevent the T-nut fasteners from loosening. Further, the plate may be attached to the frame using the adjustable two-piece fastener and the components outlined previously, shown from a front ISO perspective. Each of these completed BHP2 units incorporates a swivel leveling mount system, which is secured to the bottom of the frame at four corners using a ¼-20 threaded stud and T-nut.

Further, the diffusion plate has a pot area of 380.19 square inches and a thickness of 0.75 inches. As shown in FIG. 24 displays the calculated thermal resistance of 511 u-° C./W for the diffusion plate.

Further, the control devices function as energy regulators specifically for electric ranges, designed to be installed on a control panel and requiring only a small footprint. They regulate the burner's heat output by adjusting the electrical current supplied to the heating element. By integrating energy regulators, one can achieve precise temperature control over significant volumes of boiling wort or water, ensuring a consistent rolling boil with high-temperature liquids. Three energy regulators are employed in concert to regulate three heaters that are thermally connected to the diffusion plate. High-temperature wire is utilized to connect the energy regulators to the heaters.

The fully assembled BHP2 includes a control enclosure and panel that provide an efficient method for connecting and disconnecting input power. This system delivers switchable Ground Fault Circuit Interrupter (GFCI)-protected power for pumps, lighting, and various other loads while effectively managing the power to the burners to control the energy supplied to the liquids in the brew pot during brewing. Additionally, three incandescent lamps indicate when power is present across the burner coils.

Mounted on the lower left-hand side of the enclosure is a flanged female inlet connector (CS6375L), rated for 50 A at 125/250V. This location was chosen to keep the heavy cable closer to the floor, which reduces the stress on the connector. The associated cable connector (CS6364L) has a male body, also rated for 50 A at 125/250V, and is compatible with flexible SOOW wire up to #8/3 gauge (35A). Both connectors include a 3-pole, 4-wire grounding configuration.

Further, the BHP2's control enclosure and panel were developed to oversee three single-element 8-inch Calrod heaters, each rated at 2.2 KW. It features three infinite switches (WB24T10025) that enable fine-tuned power adjustments in concert but independent of each other, allowing for better management of heat flow into the brew pot. This innovation is a notable upgrade from the BHP prototype, which had six switches and 64 power settings. Incandescent lamps on the front panel indicate when power is present across the burner coils. The front panel includes a switch that operates a food-grade magnet drive water pump, which is essential for transferring strike water either into the mash tun or into the hot liquor tank for the sparging process.

The enclosure and front panel wiring conform to UL 508A, the acknowledged standard for industrial control panels. For ease of assembly and testing, the branch circuit breaker circuitry is systematically arranged and mounted on the internal enclosure panel that is compatible with the enclosure. Input wires originating from the inlet connector are attached to the terminal block positioned at the upper section of the panel and are then connected to the breakers' input. The output from the breakers is directed to a terminal block at the lower part of the panel, which connects to a 15-pin female Molex connector. The wires coming from the burners within the electrical box are channeled through the conduit and terminated at the terminal block at the bottom of the enclosure panel.

Ferrules are utilized in conjunction with a square crimper to elevate the quality and reliability of wiring. The flat configuration of the crimps enlarges the contact area, which contributes to a decrease in contact resistance. Insulated female lugs, which are double crimped, are utilized to connect the infinite switches and pump switch to the 15-pin male Molex connector. Wires are bundled neatly with tie wraps.

Further, the disclosed apparatus includes a fully assembled enclosure along with the control panel. Labels serve to indicate the identity of each component within the enclosure. The two connectorized circuit assemblies are linked via a 15-pin Molex connector.

Further, the utilization of a temperature controller to manage solid state relays is not yet implemented. But the said implementation is obvious to one skilled in the art of power electronics. The Crydom D2425D Dual Solid-State Relay has been chosen to regulate power to the burners. High-Speed Cylindrical Fuses (Protistor) have been selected to protect the solid-state relay during overload conditions. The fuse rating is 690 VAC, 20 A, with dimensions of 10 mm×38 mm.

Further, the branch circuit breakers would be removed from the control enclosure, and fuses would be wired in each leg of the 240 V RMS heaters if solid-state devices are used. A temperature controller would be mounted on the control panel with the correct LED drive capability to turn on and off the solid-state devices. The input power for the controller would be either 120/240 V RMS AC or low voltage DC, where 12/24 V are common voltage level used for control circuits.

Further, the BHP2 build comprises three A&B bracket assemblies, nine adjustable slotted screw assemblies, and four adjustable fasteners. Steel conduit hangers secure the wire conduit on the horizontal extrusions. To ensure the protection of receptacle wires inside the electrical box, bushing conduit fittings are utilized.

Further, the electrical box is mounted to bracket B after the wires are connected to the burners through the receptacle block. Further, the electrical box is secured with the metal receptacle bracket, and the wires are run through the conduit to the enclosure (controller). Further, a ground wire attachment is made to the electrical box before mounting it to the racket part B.

Further, the bracket assembly, consisting of part A and part B, is secured using a screw, washer, lock washer, and nut. The mounting holes on the side of part A are slotted to provide about an inch of vertical adjustment.

Further, the electrical box, which is a component of the burner receptacle interface, features a four-sided design that is open at both the front and bottom. This design allows for the easy insertion of the Original Equipment Manufacturer (OEM) burner receptacle block from the front and bottom. The process of mounting the electrical box to Part B of the bracket assembly involves inserting screws through the box's holes. This requires four 6-32 screws and four threaded 6-32 PEM inserts, which are pressed into Part B, ensuring a reliable connection to the four holes on the electrical box. Further, the electrical box is mounted to the bracket assembly.

Further, the Receptacle Block is equipped with two uninsulated ¼-inch female terminals for establishing connections to the burners. The two terminals are pushed inside the receptacle block and locked into place. The lead tabs of the burner are inserted into the terminals, establishing an electrical connection. Subsequently, the receptacle bracket is attached to the receptacle block, securely locking the two components together. The metal receptacle bracket secures the receptacle block to the burner. A mounting screw is implemented to connect the receptacle bracket to bracket B.

Further, a fully assembled burner interface consists of the bracket assembly, receptacle block, metal receptacle bracket, terminals, conduit, and burner. The receptacle bracket is connected to bracket B with a screw. The electrical box is mounted to bracket B with four screws. Grounding is accomplished by securing the ground wire to the top of the box with a screw and nut. The conduit facilitates the entry of wires into the electrical box and is attached to the Part B mounting bracket.

Further, the application utilized three WB30M2 single-element 2.2 kW Calrod heating burners to deliver a maximum heating power of 6.6 kW at 240 V RMS. The actual power output recorded was 6300 W, with a measured line voltage of 233 V RMS.

Further, eight-inch chrome stove drip pans were installed beneath the burners to serve as heat shields, reducing heat exposure to the wiring and enhancing burner efficiency by more evenly reflecting heat back toward the diffusion plate. Flat-style end mills are used to drill holes into rounded metal surfaces on the drip pan for the purpose of mounting. The drip pan is firmly attached to the adjustable slotted screw assembly, with washers and ⅜-inch nuts. A jig is implemented to firmly hold the drip pan in position during the milling operation.

Constructed with 1-inch 6061 aluminum extruded square bars 2 inches long, the burner support bases utilize two Flanged Button Head Socket Cap Screws (FBHSCS) and two 2-Hole Inside Corner Brackets (2HICB). An adjustable screw assembly with slots is inserted into the burner support bases, providing support for the burners from the top of the frame. The slots on the upper part of the bolts are 0.15 inches by 0.56 inches and are manufactured using aluminum bolts. While steel bolts are an option, aluminum is preferred for the aluminum's milling convenience. The aluminum frame is connected to the burner support bases via two T-nuts and two FBHSCS. The above design not only secures the mounting but also provides the flexibility to adjust for different burner sizes or to incorporate additional burners without requiring any new drilling for mounting holes. Further, three 6 KW burners are positioned on the individual support assemblies. The three burners are connected using OEM receptacles and include grounded electrical boxes that are mounted to bracket B. Further, the installation of drip pans in three positions beneath the burners serves as heat shields.

Further, the fully assembled BHP includes a control enclosure and panel that provides an efficient method for connecting and disconnecting input power. This system delivers switchable Ground Fault Circuit Interrupter-protected power for pumps, lighting, and various other loads while effectively managing the power to the burners to control the energy supplied to the liquids in the brew pot during brewing. Additionally, three incandescent lamps indicate when power is present across the burner coils. The 120 V RMS power receptacle is prominently displayed on the left side of the control enclosure, positioned above the inlet connector. The front control panel features a switch that activates the pump associated with the GFCI receptacle. An incandescent lamp lights up to indicate that the pump is in operation.

Mounted on the lower left-hand side of the enclosure is a flanged female inlet connector (CS6375L), rated for 50 A at 125/250V. This location was chosen to keep the heavy cable closer to the floor, which reduces the stress on the connector. The associated cable connector (CS6364L) has a male body, also rated for 50 A at 125/250V, and is compatible with flexible SOOW wire up to #8/3 gauge (35A). Both connectors include a 3-pole, 4-wire grounding configuration.

Further, the BHP2's control enclosure and panel were developed to oversee three single element 8-inch Calrod heaters, each rated at 2.2 kW. It features three infinite switches (WB24T10025) that enable fine-tuned power adjustments in concert with each other, allowing for better management of heat flow into the brew pot. This innovation is a notable upgrade from the BHP prototype, which had six switches and 64 power settings. Incandescent lamps on the front panel indicate when power is present across the burner coils. The front panel includes a switch that operates a food-grade magnet drive water pump, which is essential for transferring strike water either into the mash tun or into the hot liquor tank for the sparging process.

Further, the enclosure and front panel wiring conform to UL 508A, the acknowledged standard for industrial control panels. For ease of assembly and testing, the branch circuit breaker circuitry is systematically arranged and mounted on the internal enclosure panel that is compatible with the enclosure. Input wires originating from the inlet connector are attached to the terminal block positioned at the upper section of the panel and are then connected to the breakers' input. The output from the breakers is directed to a terminal block at the lower part of the panel, which connects to a 15-pin female Molex connector. The wires coming from the burners within the electrical box are channeled through the conduit and terminated at the terminal block at the bottom of the internal enclosure panel.

To use the BHP2 in a brewing system, attach the cable connector (CS6364L) to the flanged female inlet connector (CS6375L) to supply power to the control enclosure. Position a pot filled with your “strike” water on the diffusion plate. Rotate the knobs on the control panel fully to the right to set the energy regulators to the high-power mode for heating the strike water. Heating the water slightly over the strike temperature. Attach the pump cord to the GFCI outlet located above the inlet connector. To begin pumping, use the pump switch on the control panel by switching it to the ‘on’ position, allowing the strike water to flow into the mash tun. After transferring the water to the mash tun, switch off the pump. Further, a paddle may be used to cool the water to the right strike temperature. Mash in the grain. Fill the pot with “sparge” water, repeating the steps that you used to heat the strike water. Move sparge water to the hot liquor tank using the pump and the on/off pump switch. Lauter wort into the pot. Heat the wort on low medium heat to gradually heat the wort. Adjust control knobs to increase heat, scoop trub, and adjust the heating temperature to generate a rolling boil. Start and complete the hop schedule. Turn off heaters by turning the control knobs fully counterclockwise. Let the energy from the diffusion plates flow into the wort before putting the top on. Switch on and off the pump as needed to circulate hot wort through the heat exchanger to cool the wort to yeast pitching temperature, 68° F. for ales and 50° F. for lagers. Add oxygen into the wort. Pitch yeast!

In some embodiments, the present disclosure describes a kilowatt heating apparatus with a diffusion plate integrated within the frame for significantly reducing the caramelization or burning of sugary wort when subjected to high heat levels, thereby decreasing the total brewing time and improving the mechanical stability of the brewing system in large-scale home beer production. The kilowatt heating apparatus with diffusion plates integrated within the frame generally includes a frame, electric heaters, diffusion plates, and a controller.

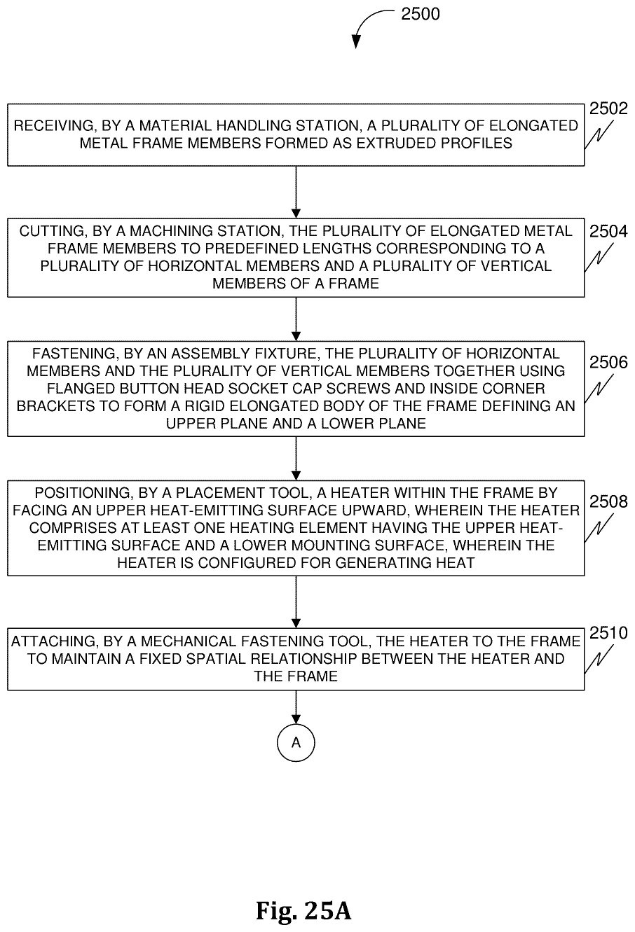

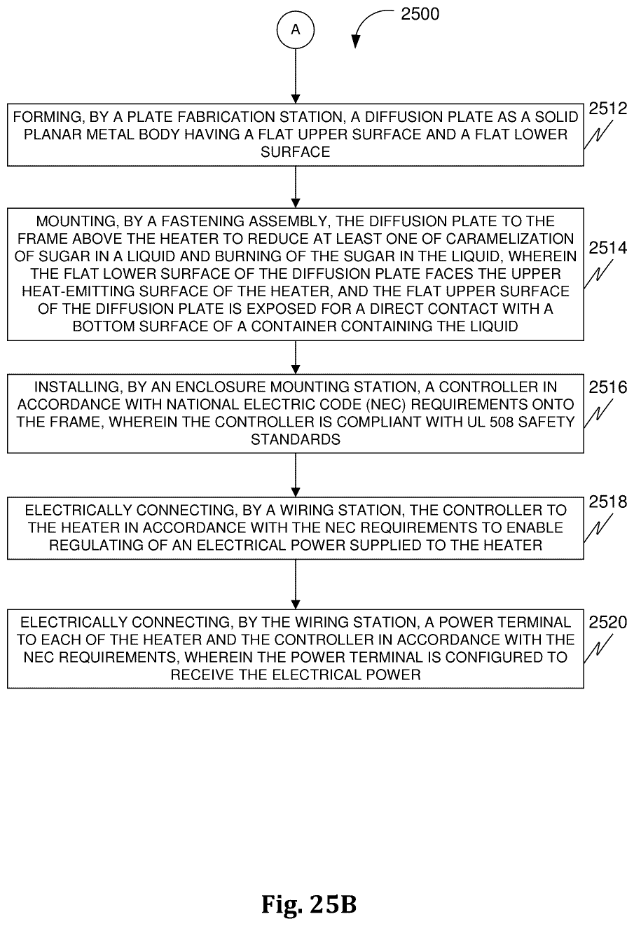

FIGS. 25A and 25B illustrate a flowchart of a method 2500 of manufacturing a kilowatt heating apparatus, in accordance with some embodiments. Further, the method 2500 may include a step 2502 of receiving, by a material handling station, two or more elongated metal frame members formed as extruded profiles. Further, the method 2500 may include a step 2504 of cutting, by a machining station, the two or more elongated metal frame members to predefined lengths corresponding to two or more horizontal members (302-308) and two or more vertical members (310 and 312) of a frame 102. Further, the method 2500 may include a step 2506 of fastening, by an assembly fixture, the two or more horizontal members (302-308) and the two or more vertical members (310 and 312) together using flanged button head socket cap screws and inside corner brackets to form a rigid elongated body of the frame 102 defining an upper plane 104 and a lower plane 106. Further, the method 2500 may include a step 2508 of positioning, by a placement tool, a heater 108 within the frame 102, facing an upper heat-emitting surface 402 upward. Further, the heater 108 includes one or more heating elements (202-206) having the upper heat-emitting surface 402 and a lower mounting surface 404. Further, the heater 108 may be configured for generating heat. Further, the method 2500 may include a step 2510 of attaching, by a mechanical fastening tool, the heater 108 to the frame 102 to maintain a fixed spatial relationship between the heater 108 and the frame 102. Further, the method 2500 may include a step 2512 of forming, by a plate fabrication station, a diffusion plate 110 as a solid planar metal body having a flat upper surface 502 and a flat lower surface 504. Further, the method 2500 may include a step 2514 of mounting, by a fastening assembly, the diffusion plate 110 to the frame 102 above the heater 108 to reduce one or more of caramelization of sugar in a liquid and burning of the sugar in the liquid. Further, the flat lower surface 504 of the diffusion plate 110 faces the upper heat-emitting surface 402 of the heater 108, and the flat upper surface 504 of the diffusion plate 110 may be exposed for a direct contact with a bottom surface of a container 112 containing the liquid. Further, the method 2500 may include a step 2516 of installing, by an enclosure mounting station, a controller 114 in accordance with National Electric Code (NEC) requirements onto the frame 102. Further, the controller 114 may be compliant with UL 508 safety standards. Further, the method 2500 may include a step 2518 of electrically connecting, by a wiring station, the controller 114 to the heater 108 in accordance with the NEC safety standards to enable regulating of an electrical power supplied to the heater 108. Further, the method 2500 may include a step 2520 of electrically connecting, by the wiring station, a power terminal 116 to each of the heater 108 and the controller 114 in accordance with the NEC safety standards. Further, the power terminal 116 may be configured to receive the electrical power.

In some embodiments, the forming of the diffusion plate 110 includes machining a monolithic metal plate body from an aluminum billet using a milling machine to produce opposing major surfaces with high thermal conductivity characteristics. Further, the diffusion plate 110 comprising the monolithic metal plate body is configured for receiving the heat and spreading the heat laterally across a continuous internal volume. Further, the reducing of one or more of the caramelization of the sugar in the liquid and the burning of the sugar in the liquid may be based on spreading the heat laterally across the continuous internal volume before the heat reaches the flat upper surface 502.

Further, in some embodiments, the milling machine may include a CNC module and a water jet cutting module.

In some embodiments, the forming of the diffusion plate 110 includes controlling a thickness of the diffusion plate 110 during machining to define a thermal mass capable of storing the heat transferred from the heater 108 to the bottom surface of the container 112. Further, the thickness ranges between 0.5 and 1 inch.

Further, the diffusion plate 110 may be formed from a component material. Further, the component material may include one or more of aluminum and steel.

In some embodiments, the mounting of the diffusion plate 110 includes fastening the diffusion plate 110 to the frame 102 at two or more perimeter attachment locations using two or more threaded fasteners to transfer a structural load into the frame 102. Further, the frame 102 integrated with the diffusion plate 110 is configured to support a load exceeding 250 lbs. Further, the supporting of the load exceeding 250 lbs comprises supporting the container 112 containing the liquid with a quantity of 30 gallons.

In some embodiments, the forming of the diffusion plate 110 further includes surface machining the flat upper surface 502 of the diffusion plate 110 to a substantially planar geometry to reduce thermal interface resistance with the container 112. Further, the diffusion plate 110 is characterized by a maximum surface flatness tolerance of 5 mils across a span of 2 feet. Further, the diffusion plate 110 comprising the maximum surface flatness tolerance of 5 mils prevents a mechanical chattering between the container 112 containing the liquid and the diffusion plate 110, when applying high-power from the heaters 108.

Further, in some embodiments, the forming of the diffusion plate 110 further includes surface machining the flat lower surface 504 of the diffusion plate for achieving a flatness tolerance of approximately 5 mi-inches (0.005 inches) over a span of 2 feet. Further, the surface machining of the flat lower surface 504 minimizes a contact resistance and a thermal resistance associated relative to the diffusion plate 110.

In some embodiments, the mounting of the diffusion plate 110 above the heater 108 includes positioning the diffusion plate 110 above the heater 108 for receiving the one or more of a conductive heat through conductive heat transfer and radiant heat through radiative heat transfer. Further, the mounting of the diffusion plate 110 above the heater 108 includes resting a load of the diffusion plate 110 on the upper heat-emitting surface 402 of the one or more heating elements (202-206). Further, the mounting of the diffusion plate 110 above the heater 108 includes securing the diffusion plate 110 to the frame 102 using two or more mechanical fasteners (118-124).

In some embodiments, the mounting of the diffusion plate 110 includes maintaining a fixed vertical spacing between the heater 108 and the diffusion plate 110 to enable high-power heat transfer without a localized overheating.

In some embodiments, the fastening of the two or more horizontal members (302-308) and the two or more vertical members (310 and 312) together includes constraining the diffusion plate 110 and the heater 108 in a fixed spatial alignment to ensure repeatable thermal performance.

In some embodiments, the container 112 may contain a sugary wort. Further, the forming of the diffusion plate 110 includes forming the diffusion plate 110 which may be configured to transfer the heat to the bottom surface uniformly for inducing a rolling boil of the sugary wort. Further, the rolling boil of the sugary wort facilitates a volatilization of a sulfur compound of the sugary wort.

In some embodiments, the positioning of the heater 108 comprises positioning the one or more heating elements (202-206) comprising the lower mounting surface 404. Further, the lower mounting surface 404 may be configured to support the one or more heating elements (202-206) against the flat lower surface 504 of the diffusion plate 110 to minimize a thermal conduction resistance due to an air gap existing between the one or more heating elements (202-206) and the flat lower surface 504 of the diffusion plate 110.

In some embodiments, the forming of the diffusion plate 110 includes forming the diffusion plate 110 which may be configured to reduce a thermal hot spot across the bottom surface of the container 112 by performing one or more of receiving the heat from the upper heat-emitting surface 402 and spreading the heat laterally across a continuous internal volume of the diffusion plate 110 before the heat reaches the flat upper surface 502. Further, the reducing of one or more of the caramelization of the sugar in the liquid and the burning of the sugar in the liquid may be based on the reducing of the thermal hot spot of the container 112.

In some embodiments, the installing of the controller 114 includes installing the controller 114 comprising one or more circuit breakers (1202-1206). Further, the one or more circuit breakers (1202-1206) may be electrically coupled with the one or more heating elements (202-206). Further, the one or more heating elements (202-206) may include a wiring. Further, the one or more circuit breakers (1202-1206) may be configured to protect the wiring of the one or more heating elements (202-206) from an electrical damage.

Further, the one or more heating element components may include one or more of wirings, connectors, and contacts associated with the one or more heating elements.

In some embodiments, the positioning of the heater 108 includes attaching one or more thermal shields (602-606) to the frame 102 for distributing a heat emission across the flat lower surface 504 of the diffusion plate 110.

In some embodiments, the mounting of the diffusion plate 110 includes securing corner regions of the diffusion plate 110 to the frame 102 using two or more mechanical fasteners (118-124) to suspend a central region of the diffusion plate above the heater.

In some embodiments, the forming of the diffusion plate 110 includes selecting a plate thickness sufficient to resist an elastic deformation under a load of the container 112 during heating.

In some embodiments, the installing of the controller 114 includes installing the controller 114 comprising one or more regulators (1302-1306). Further, the regulating of the electrical power includes regulating the electrical power supplied to the heater based on one or more actions applied to the one or more regulators (1302-1306) by one or more users.

Further, in some embodiments, the controlling of the one or more heating elements (202-206) further comprises terminating the electrical power supplied to the one or more heating elements (202-206) based on one or more actions applied to the one or more regulators (1302-1306) by one or more users.

In some embodiments, the attaching of the heater 108 to the frame 102 includes installing two or more adjustable support members (314-330) on a top of the two or more horizontal members (302-308) using a flanged button head socket cap screws with inside corner brackets. Further, the two or more adjustable support members (314-330) comprise two or more slotted headed screws configured to support a mounting frame of the one or more heating elements (202-206). Further, the lower mounting surface 404 comprises the mounting frame. Further, the attaching of the heater 108 to the frame 102 includes adjusting a height of the two or more adjustable support members (314-330) for securing the one or more heating elements (202-206) against the diffusion plate 110. Further, the securing of the one or more heating elements (202-206) against the diffusion plate 110 reduces a thermal contact resistance between the one or more heating elements (202-206) and the diffusion plate 110. Further, the two or more adjustable support members (314-330) may be configured to define a variable vertical position for the one or more heating elements (202-206) relative to the diffusion plate 110.

In some embodiments, the mounting of the diffusion plate 110 comprises securing two or more mechanical fasteners (118-124) to two or more corners of the two or more horizontal members (302-308). Further, the mounting of the diffusion plate 110 comprises securing corner regions of the diffusion plate 110 to the frame 102 using the two or more mechanical fasteners (118-124) to suspend a central region of the diffusion plate 110 above the heater 108. Further, the load of the diffusion plate 110 and the load of the container 112 comprising liquid may be supported by each of the two or more mechanical fasteners and the two or more adjustable support members (314-330) supporting the one or more heating elements (202-206). Further, each of the two or more mechanical fasteners (118-124) and the two or more adjustable support members (314-330) is in direct contact with the two or more horizontal members (302-308) of the frame 102.

In some embodiments, the positioning of the heater 108 comprises attaching one or more thermal shields (602-606) to the two or more slotted headed screws. Further, the one or more thermal shields (602-606) comprises two or more holes (1002 and 1004) configured to receive the two or more slotted headed screws. Further, the one or more thermal shields (602-606) may be configured to allow a contact between the mounting frame and the two or more slotted headed screws after attaching the one or more thermal shields (602-606) to the two or more slotted headed screws. Further, the positioning of the heater 108 comprises adjusting a height of the one or more thermal shields (602-606) to positioning the one or more thermal shields (602-606) beneath the one or more heating elements (202-206). Further, the one or more thermal shields (602-606) may be configured for distributing a heat emission across the flat lower surface 504 of the diffusion plate 110. Further, the one or more thermal shields (602-606) may be further configured to shield one or more wiring components from the heat.

In some embodiments, the method 2500 further comprises installing, by the mechanical fastening tool, an electrical conduit 338 in an inner surface of the two or more horizontal members (302-308). Further, the electrical conduit 338 may be configured to provide a passageway for a conductive wire from the controller 114 to a receptacle block 902. Further, the method 2500 further comprises mounting, by the mechanical fastening tool, a bracket assembly (332-336) on the two or more horizontal members (302-308) by aligning a circular opening of the bracket assembly (332-336) with the threaded connector of the electrical conduit 338. Further, the electrical conduit 338 may be routed to the bracket assembly 332. Further, the circular opening may be configured to receive a threaded connector of the electrical conduit 338. Further, the bracket assembly (332-336) may be further configured to receive the one or more electric boxes (208-212). Further, the method 2500 further comprises mounting, by the mechanical fastening tool, the one or more electric boxes (208-212) on the bracket assembly (332-336). Further, the method 2500 further comprises securing, by the mechanical fastening tool, the receptacle block 902 in the bracket assembly (332-336) using the one or more electric boxes (208-212). Further, the receptacle block 902 comprises two uninsulated female terminals (1602 and 1604). Further, the method 2500 further comprises connecting, by a wiring tool, the conductive wire extending from the controller to the receptacle block 902 using the two uninsulated female terminals (1602 and 1604). Further, the method 2500 further comprises inserting, by a fastening tool, two male electrodes of the one or more heating elements (202-206) into the receptacle block 902 to establish a connection between the two uninsulated female terminals (1602 and 1604) and the two male electrodes of the one or more heating elements (202-206). Further, the generating of the heat may be based on the establishing of the connection between the two uninsulated female terminals (1602 and 1604) and the two male electrodes.

In some embodiments, the method 2500 further comprises securing, by a mechanical fastening tool, the receptacle block 902 with the one or more heating elements (202-206) using a metal receptacle bracket 904.

In some embodiments, the method 2500 further comprises securing, by the wiring tool, a ground wire inside the one or more electric boxes (208-212) using a designated hole with screws and nuts. Further, the mounting of the one or more electric boxes (208-212) occurs after the securing of the ground wire. Further, the mounting of the one or more electric boxes (208-212) comprises mounting the one or more electric boxes (208-212) on the bracket assembly (332-336) using screws. Further, the bracket assembly (332-336) comprises PEM inserts (fastener) for the mounting of the one or more electric boxes (208-212).

In some embodiments, the installing of the controller 114 includes installing the controller 114 comprising one or more indicators (1402-1406). Further, the one or more indicators (1402-1406) may be configured to generate a first light based on the regulating of the electrical power supplied to the heater. Further, the first light indicates a status of the regulating of the electrical power supplied to the heater.

In some embodiments, the mounting of the diffusion plate 110 includes defining an air gap between the heater 108 and the diffusion plate 110 to moderate a direct conductive heat transfer.

In some embodiments, the fastening of the two or more horizontal members (302-308) and the two or more vertical members (310 and 312) together includes forming a mounting interface which may be configured to receive one or more electric boxes (208-212) without obstructing a heat transfer between the heater and the diffusion plate 110.

In some embodiments, the fastening of the two or more horizontal members (302-308) and the two or more vertical members (310 and 312) together includes assembling the frame 102 as an open structural geometry supporting the diffusion plate while allowing an airflow around the heater 108.

In some embodiments, the electrically connecting of the controller 114 comprises electrically connecting the controller 114 to the heater 108 using conductive wiring meeting NEC standards to enable the regulating of the electrical power supplied to the heater 108.

Although the invention has been explained in relation to its preferred embodiment, it is to be understood that many other possible modifications and variations can be made without departing from the spirit and scope of the invention as hereinafter claimed.

What is claimed is:

1. A heating apparatus for facilitating uniform high-power heating of liquid, the heating apparatus comprising:
a frame comprising a rigid elongated body formed from a plurality of horizontal members and a plurality of vertical members joined to define an open structure having an upper plane and a lower plane, wherein the frame is configured for supporting a load above the upper plane;
a heater comprising at least one heating element formed as a continuous metal coil having an upper heat-emitting surface and a lower mounting surface, wherein the heater is mechanically attached to the frame, wherein the upper heat-emitting surface of the heater is oriented upward, wherein the heater is configured for generating heat;
a diffusion plate comprising a solid planar metal body having a flat upper surface and a flat lower surface, wherein the diffusion plate is positioned above the heater, wherein the diffusion plate is mechanically integrated with the frame, wherein the flat lower surface of the diffusion plate faces the upper heat-emitting surface of the heater to receive the heat from the upper heat-emitting surface, wherein the flat upper surface of the diffusion plate is configured for direct contact with a bottom surface of a container containing the liquid, wherein the flat upper surface is configured for transferring the heat to the bottom surface of the container uniformly to reduce at least one of caramelization of sugar in the liquid and burning of the sugar in the liquid on the bottom surface of the container;
a controller electrically connected to the heater, wherein the controller is configured for regulating an electrical power supplied to the heater to control the generating of the heat; and
a power terminal configured to receive the electrical power, wherein the power terminal is electrically connected to each of the heater and the controller.

2. The heating apparatus of claim 1, wherein the solid planar metal body of the diffusion plate is a monolithic metal plate body having a continuous internal volume, wherein the monolithic metal plate body is formed from a material exhibiting high thermal conductivity, wherein the heat received from the upper heat-emitting surface at a localized region on the flat lower surface spreads laterally across the continuous internal volume before the heat reaches the flat upper surface, wherein the reducing of at least one of the caramelization of the sugar in the liquid and the burning of the sugar in the liquid is based on spreading the heat laterally across the continuous internal volume before the heat reaches the flat upper surface.

3. The heating apparatus of claim 1, wherein the diffusion plate has a predetermined thickness measured between the flat upper surface and the flat lower surface, wherein the predetermined thickness of the diffusion plate defines a thermal mass configured to perform an absorption of the heat from the upper heat-emitting surface and temporarily storing the heat prior to the transferring of the heat to the bottom surface of the container uniformly, wherein the predetermined thickness of the diffusion plate ranges from 0.5 inch to 1 inch.

4. The heating apparatus of claim 1, wherein the diffusion plate is mechanically integrated with the frame by a plurality of fixed attachments at a plurality of spaced locations along a perimeter of the diffusion plate, wherein the plurality of spaced locations is configured to transfer the load from the diffusion plate directly into the frame, wherein the frame integrated with the diffusion plate is configured for supporting a load exceeding 250 lbs, wherein the supporting of the load exceeding 250 lbs comprises supporting the container containing the liquid with a quantity of 30 gallons.

5. The heating apparatus of claim 1, wherein the flat upper surface of the diffusion plate is machined to a substantially flat planar geometry over an area corresponding to the bottom surface of the container to reduce an air gap at an interface between the diffusion plate and the container, wherein the diffusion plate is characterized by a maximum surface flatness tolerance of 5 mils across a span of 2 feet, wherein the maximum surface flatness tolerance prevents a mechanical chattering between the container containing the liquid and the diffusion plate.

6. The heating apparatus of claim 1, wherein the diffusion plate is arranged as a physical barrier positioned between the heater and the container, wherein the receiving of the heat from the upper heat-emitting surface comprises receiving the heat by conduction and/or radiation, wherein the transferring of the heat to the bottom surface of the container is further based on the receiving of the heat by the conduction and/or the radiation.

7. The heating apparatus of claim 1, wherein the diffusion plate is configured for receiving the heat from the upper heat-emitting surface at a power level sufficient to raise a temperature of the diffusion plate above a boiling temperature of the liquid by maintaining a distributed temperature profile across the flat upper surface, wherein the container contains the liquid.

8. The heating apparatus of claim 1, wherein the frame defines a fixed mounting geometry constraining the diffusion plate at a predetermined vertical spacing relative to the heater to maintain consistent alignment between the heater and the diffusion plate during an operation, wherein the operation comprises converting the electrical energy into the heat, receiving the heat from the upper heat-emitting surface, and transferring the heat to the bottom surface of the container.

9. The heating apparatus of claim 3, wherein the liquid comprises sugary wort, wherein a thermal capacitance of the diffusion plate regulates a change in a temperature of the sugary wort, wherein the thermal capacitance of the diffusion plate is the absorption of the heat by the diffusion plate and the storing of the heat in the diffusion plate, wherein the controller comprises a proportional-integral-derivative (PID) temperature controller coupled with the diffusion plate, wherein the controller further comprises a solid-state relay and a mechanical relay coupled with the PID temperature controller, wherein the PID temperature controller is configured to determine a quantity of the electrical power to be supplied to the heater based on a temperature of the diffusion plate and the temperature of the sugary wort, wherein the regulating of the electrical power supplied to the heater comprises regulating the electrical power supplied to the heater using the solid-state relay based on the determining of the quantity of the electrical power.

10. The heating apparatus of claim 2, wherein the diffusion plate is configured to reduce a thermal hot spot across the bottom surface of the container by performing at least one of the receiving of the heat from the upper heat-emitting surface of the heater and the spreading of the heat laterally across the continuous internal volume of the diffusion plate before the heat reaches the flat upper surface, wherein the reducing of at least one of the caramelization of the sugar in the liquid and the burning of the sugar in the liquid is based on the reducing of the thermal hot spot of the container.

11. The heating apparatus of claim 1, wherein the controller comprises at least one circuit breaker, wherein the at least one circuit breaker is electrically coupled with the at least one heating element, wherein the at least one heating element comprises a wiring, wherein the at least one circuit breaker is configured to protect the wiring of the at least one heating element from an electrical damage.

12. The heating apparatus of claim 1, wherein the solid planar metal body is an aluminum plate body, wherein the aluminum plate body is characterized by a thickness sufficient to resist an elastic deformation of the diffusion plate during high thermal excursions from the heater and under the load applied by the container to maintain a surface flatness of the diffusion plate during the heating of the liquid.

13. The heating apparatus of claim 1, wherein the controller comprises at least one regulator, wherein the regulating of the electrical power supplied to the heater comprises regulating the electrical power supplied to the at least one heating element based on at least one action applied to the at least one regulator by at least one user.

14. The heating apparatus of claim 1 further comprising a plurality of adjustable support members mounted on a top of the plurality of horizontal members and positioned beneath the at least one heating element, wherein the plurality of adjustable support members comprises a plurality of slotted headed screws configured to support a mounting frame of the at least one heating element, wherein the lower mounting surface comprises the mounting frame, wherein the plurality of adjustable support members is configured to define a variable vertical position for the at least one heating element relative to the diffusion plate for securing the at least one heating element against the diffusion plate, wherein the securing of the at least one heating element against the diffusion plate reduces a thermal contact resistance between the at least one heating element and the diffusion plate.

15. The heating apparatus of claim 14, wherein the diffusion plate is mechanically integrated with the frame at a plurality of discrete corner regions using a plurality of mechanical fasteners extending through the diffusion plate and into the frame, wherein the mechanical fasteners are positioned to suspend a central region of the diffusion plate above the heater, wherein a load of the diffusion plate and the load of the container comprising the liquid is supported by each of the plurality of mechanical fasteners and the plurality of adjustable support members supporting the at least one heating element, wherein each of the plurality of mechanical fasteners and the plurality of adjustable support members is in direct contact with the plurality of horizontal members of the frame.

16. The heating apparatus of claim 14, wherein the heater further comprises at least one thermal shield formed as a continuous curved metal element, wherein the at least one thermal shield is attached to the plurality of slotted headed screws and positioned beneath the at least one heating element, wherein the at least one thermal shield comprises a plurality of holes configured to receive the plurality of slotted headed screws, wherein the at least one thermal shield is configured to allow a contact between the mounting frame and the plurality of slotted headed screws after attaching the at least one thermal shield to the plurality of slotted headed screws, wherein the continuous curved metal element defines a distributed heat-emission profile directed toward the flat lower surface of the diffusion plate, wherein the at least one thermal shield is further configured to shield at least one wiring component from the heat.

17. The heating apparatus of claim 1, wherein the heating apparatus further comprises a pump fluidly coupled with the container, wherein the pump is configured for moving a hot liquid at least one of from the container to at least one additional container and from the at least one additional container to the container based on a power received by the pump, wherein the controller comprises a Ground Fault Circuit Interrupter (GFCI) breaker configured for interrupting the power supplied to the pump in response to a ground fault, wherein the interrupting of the power protects the controller against an electrical leakage.

18. The heating apparatus of claim 1 further comprising:
an electrical conduit extending between the controller and the at least one heating element, wherein the electrical conduit is attached to an inner surface of the plurality of horizontal members, wherein the electrical conduit is configured to provide a passageway for a conductive wire from the controller to a receptacle block, wherein the controller is electrically coupled with the heater using the conductive wire;
a bracket assembly mounted on the plurality of horizontal members, wherein the electrical conduit is routed to the bracket assembly, wherein the bracket assembly comprises a circular opening configured to receive a threaded connector of the electrical conduit, wherein the bracket assembly is further configured to receive at least one electric box;
the at least one electric box mounted on the bracket assembly, wherein the at least one electric box is configured to secure the receptacle block in the bracket assembly; and
the receptacle block comprising two uninsulated female terminals, wherein the conductive wire extending from the controller is connected to the receptacle block using the two uninsulated female terminals, wherein the receptacle block is configured to receive two male electrodes of the at least one heating element to establish a connection between the two uninsulated female terminals and the two male electrodes of the at least one heating element, wherein the generating of the heat is based on the establishing of the connection between the two uninsulated female terminals and the two male electrodes.

19. A heating apparatus for facilitating uniform high-power heating of liquid, the heating apparatus comprising:
a frame configured for supporting a container;
a heater attached to the frame, wherein the heater is configured for generating heat;
a diffusion plate mechanically integrated with the frame, wherein the diffusion plate is positioned between the heater and the container, wherein the diffusion plate is configured for:
receiving the heat from the heater; and
distributing the heat uniformly to the container containing the liquid, wherein the liquid comprises sugar, wherein the distributing of the heat uniformly to the container reduces at least one of caramelization of the sugar in the liquid and burning of the sugar in the liquid on the bottom surface of the container; and
a controller electrically coupled to the heater, wherein the controller is configured for regulating an electrical power supplied to the heater to control the generating of the heat.

20. A heating apparatus for facilitating uniform high-power heating of liquid, the heating apparatus comprising:
a frame comprising a rigid elongated body formed from a plurality of horizontal members and a plurality of vertical members joined to define an open structure having an upper plane and a lower plane, wherein the frame is configured for supporting a load above the upper plane;
a heater comprising at least one heating element formed as a continuous metal coil having an upper heat-emitting surface and a lower mounting surface, wherein the heater is mechanically attached to the frame by facing the upper heat-emitting surface upward, wherein the heater is configured for generating heat;
a diffusion plate comprising a solid planar metal body having a flat upper surface and a flat lower surface, wherein the diffusion plate is positioned above the heater, wherein the diffusion plate is mechanically integrated with the frame, wherein the flat lower surface of the diffusion plate faces the upper heat-emitting surface of the heater to receive the heat from the upper heat-emitting surface, wherein the flat upper surface of the diffusion plate is configured for direct contact with a bottom surface of a container containing the liquid, wherein the flat upper surface is configured for transferring the heat to the bottom surface of the container uniformly to reduce at least one of caramelization of sugar in the liquid and burning of the sugar in the liquid on the bottom surface of the container, wherein the solid planar metal body of the diffusion plate is a monolithic metal plate body having a continuous internal volume and a plurality of opposing major faces, wherein the monolithic metal plate body is formed from a material exhibiting high thermal conductivity, wherein the heat is received from the upper heat-emitting surface at a localized region on the flat lower surface spreads laterally across the continuous internal volume before the heat reaches the flat upper surface, wherein the transferring of the heat to the bottom surface is based on the reaching of the heat in the flat upper surface;
a controller electrically connected to the heater, wherein the controller is configured for regulating an electrical power supplied to the heater to control the generating of the heat; and
a power terminal configured to receive the electrical power, wherein the power terminal is electrically connected to each of the heater and the controller.

21. A method of manufacturing a heating apparatus, the method comprising:
receiving, by a material handling station, a plurality of elongated metal frame members formed as extruded profiles;
cutting, by a machining station, the plurality of elongated metal frame members to predefined lengths corresponding to a plurality of horizontal members and a plurality of vertical members of a frame;
fastening, by an assembly fixture, the plurality of horizontal members and the plurality of vertical members together using flanged button head socket cap screws and inside corner brackets to form a rigid elongated body of the frame defining an upper plane and a lower plane;
positioning, by a placement tool, a heater within the frame by facing an upper heat-emitting surface upward, wherein the heater comprises at least one heating element having the upper heat-emitting surface and a lower mounting surface, wherein the heater is configured for generating heat;
attaching, by a mechanical fastening tool, the heater to the frame to maintain a fixed spatial relationship between the heater and the frame;
forming, by a plate fabrication station, a diffusion plate as a solid planar metal body having a flat upper surface and a flat lower surface;
mounting, by a fastening assembly, the diffusion plate to the frame above the heater to reduce at least one of caramelization of sugar in a liquid and burning of the sugar in the liquid, wherein the flat lower surface of the diffusion plate faces the upper heat-emitting surface of the heater, and the flat upper surface of the diffusion plate is exposed for a direct contact with a bottom surface of a container containing the liquid;
installing, by an enclosure mounting station, a controller in accordance with National Electric Code (NEC) requirements onto the frame, wherein the controller is compliant with UL 508 safety standards;
electrically connecting, by a wiring station, the controller to the heater in accordance with the NEC requirements to enable regulating of an electrical power supplied to the heater; and
electrically connecting, by the wiring station, a power terminal to each of the heater and the controller in accordance with the NEC requirements, wherein the power terminal is configured to receive the electrical power.

22. The method of claim 21, wherein the forming of the diffusion plate comprises machining a monolithic metal plate body from an aluminum billet using a milling machine to produce opposing major surfaces with high thermal conductivity characteristics, wherein the diffusion plate comprising the monolithic metal plate body is configured for receiving the heat and spreading the heat laterally across a continuous internal volume, wherein the reducing of at least one of the caramelization of the sugar in the liquid and the burning of the sugar in the liquid is based on spreading the heat laterally across the continuous internal volume before the heat reaches the flat upper surface.

23. The method of claim 21, wherein the forming of the diffusion plate comprises controlling a thickness of the diffusion plate during machining to define a thermal mass capable of storing the heat transferred from the heater to the bottom surface of the container, wherein the thickness ranges from 0.5 inch to 1 inch.

24. The method of claim 21, wherein the mounting of the diffusion plate comprises fastening the diffusion plate to the frame at a plurality of perimeter attachment locations using a plurality of threaded fasteners to transfer a structural load into the frame, wherein the frame integrated with the diffusion plate is configured for supporting a load exceeding 250 lbs, wherein the supporting of the load exceeding 250 lbs comprises supporting the container containing the liquid with a quantity of 30 gallons.

25. The method of claim 21, wherein the forming of the diffusion plate further comprises surface machining the flat upper surface of the diffusion plate to a substantially planar geometry to reduce thermal interface resistance with the container, wherein the diffusion plate is characterized by a maximum surface flatness tolerance of 5 mils across a span of 2 feet, wherein the diffusion plate comprising the maximum surface flatness tolerance of 5 mils prevent a mechanical chattering between the container containing the liquid and the diffusion plate.

26. The method of claim 21, wherein the mounting of the diffusion plate above the heater comprises:
positioning the diffusion plate above the heater for receiving the heat conduction and/or radiation;
resting a load of the diffusion plate on the upper heat-emitting surface of the at least one heating element; and
securing the diffusion plate to the frame using a plurality of mechanical fasteners.

27. The method of claim 21, wherein the mounting of the diffusion plate comprises maintaining a fixed vertical spacing between the heater and the diffusion plate to enable high-power heat transfer without a localized overheating.

28. The method of claim 21, wherein the fastening of the plurality of horizontal members and the plurality of vertical members together comprises constraining the diffusion plate and the heater in a fixed spatial alignment to ensure repeatable thermal performance.

29. The method of claim 21, wherein the positioning of the heater comprises positioning the at least one heating element comprising the lower mounting surface, wherein the lower mounting surface is configured to support the at least one heating element against the flat lower surface of the diffusion plate to minimize a thermal conduction resistance due to an air gap existing between the at least one heating element and the flat lower surface of the diffusion plate.

30. The method of claim 21, wherein the forming of the diffusion plate comprises forming the diffusion plate configured to reduce a thermal hot spot across the bottom surface of the container by performing at least one of receiving the heat from the upper heat-emitting surface and spreading the heat laterally across the continuous internal volume before the heat reaches the flat upper surface, wherein the reducing of at least one of the caramelization of the sugar in the liquid and the burning of the sugar in the liquid is based on the reducing of the thermal hot spot of the container.

31. The method of claim 21, wherein the installing of the controller comprises installing the controller comprising at least one circuit breaker, wherein the at least one circuit breaker is electrically coupled with the at least one heating element, wherein the at least one heating element comprises a wiring, wherein the at least one circuit breaker is configured to protect the wiring of the at least one heating element from an electrical damage.

32. The method of claim 21, wherein the forming of the diffusion plate comprises selecting a plate thickness sufficient to resist an elastic deformation under a load of the container during heating.

33. The method of claim 21, wherein the installing of the controller comprises installing the controller comprising at least one regulator, wherein the regulating of the electrical power comprises regulating the electrical power supplied to the heater based on at least one action applied to the at least one regulator by at least one user.

34. The method of claim 21, wherein the attaching of the heater to the frame comprises:
installing a plurality of adjustable support members on a top of the plurality of horizontal members using a flanged button head socket cap screws with inside corner brackets, wherein the plurality of adjustable support members comprises a plurality of slotted headed screws configured to support a mounting frame of the at least one heating element, wherein the lower mounting surface comprises the mounting frame; and
adjusting a height of the plurality of adjustable support members for securing the at least one heating element against the diffusion plate, wherein the securing of the at least one heating element against the diffusion plate reduces a thermal contact resistance between the at least one heating element and the diffusion plate, wherein the plurality of adjustable support members is configured to define a variable vertical position for the at least one heating element relative to the diffusion plate.

35. The method of claim 34, wherein the mounting of the diffusion plate comprises:
securing a plurality of mechanical fasteners to a plurality of corners of the plurality of horizontal members; and
securing corner regions of the diffusion plate to the frame using the plurality of mechanical fasteners to suspend a central region of the diffusion plate above the heater, wherein the load of the diffusion plate and the load of the container comprising liquid is supported by each of the plurality of mechanical fasteners and the plurality of adjustable support members supporting the at least one heating element, wherein each of the plurality of mechanical fasteners and the plurality of adjustable support members is in direct contact with the plurality of horizontal members of the frame.

36. The method of claim 34, wherein the positioning of the heater comprises:
attaching at least one thermal shield to the plurality of slotted headed screws, wherein the at least one thermal shield comprises a plurality of holes configured to receive the plurality of slotted headed screws, wherein the at least one thermal shield is configured to allow a contact between the mounting frame and the plurality of slotted headed screws; and
adjusting a height of the at least one thermal shield for positioning the at least one thermal shield beneath the at least one heating element, wherein the at least one thermal shield is configured for distributing a heat emission across the flat lower surface of the diffusion plate, wherein the at least one thermal shield is further configured to shield at least one wiring component from the heat.

37. The method of claim 21, wherein the installing of the controller comprises installing the controller comprising at least one indicator, wherein the at least one indicator is configured to generate a first light based on the regulating of the electrical power supplied to the heater, wherein the first light indicates a status of the regulating of the electrical power supplied to the heater.

38. The method of claim 21 further comprising:
installing, by the mechanical fastening tool, an electrical conduit in an inner surface of the plurality of horizontal members, wherein the electrical conduit is configured to provide a passageway for a conductive wire from the controller to a receptacle block;
mounting, by the mechanical fastening tool, a bracket assembly on the plurality of horizontal members by aligning a circular opening of the bracket assembly with the threaded connector of the electrical conduit, wherein the electrical conduit is routed to the bracket assembly, wherein the circular opening is configured to receive the threaded connector of the electrical conduit, wherein the bracket assembly is further configured to receive an at least one electric box;
mounting, by the mechanical fastening tool, the at least one electric box on the bracket assembly;
securing, by the mechanical fastening tool, the receptacle block in the bracket assembly using the at least one electric box, wherein the receptacle block comprising two uninsulated female terminals;
connecting, by a wiring tool, the conductive wire extending from the controller to the receptacle block using the two uninsulated female terminals; and
inserting, by a fastening tool, two male electrodes of the at least one heating element into the receptacle block to establish a connection between the two uninsulated female terminals and the two male electrodes of the at least one heating element, wherein the generating of the heat is based on the establishing of the connection.

39. The method of claim 38 further comprising securing, by a mechanical fastening tool, the receptacle block with the at least one heating element using a metal receptacle bracket.

40. The method of claim 38 further comprising securing, by the wiring tool, a ground wire inside the at least one electric box using a designated hole with screws and nuts, wherein the mounting of the at least one electric box occurs after the securing of the ground wire, wherein the mounting of the at least one electric box comprises mounting the at least one electric box on the bracket assembly using screws, wherein the bracket assembly comprises fasteners for the mounting of the at least one electric box.
